(19) United States
(12) Patent Application Publication
(10) Pub. No.: US 2008/0081124 A1
(43) Pub. Date: Apr. 3, 2008

(54) INK JET INK COMPOSITION, AND IMAGE FORMATION METHOD AND RECORDED MATERIAL EMPLOYING SAME

(75) Inventors: Shojiro SANO, SHIZUOKA (JP); Takehiko SATO, KANAGAWA (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, TOKYO (JP)

(21) Appl. No.: 11/865,369

(22) Filed: Oct. 1, 2007

(30) Foreign Application Priority Data
Sep. 29, 2006 (JP) 2006-268302

(51) Int. Cl. C09D 11/10; B05D 3/06

(52) U.S. Cl. 427/508; 522/71

(57) ABSTRACT

An inkjet ink composition is provided that includes a polymerizable compound, a photopolymerization initiator, and a metal powder. There is also provided an image formation method that includes an image recording step of recording an image on a recording material by inkjet recording in which the inkjet ink composition is discharged, and an image curing step of curing the image recorded on the recording material in the image recording step by irradiation with actinic radiation. Furthermore, there is provided a recorded material formed by s using the inkjet ink composition.

### BACKGROUND OF THE INVENTION

1. Field of the Invention

The present invention relates to an inkjet ink composition, and an image formation method and a recorded material employing same.

2. Description of the Related Art

As an inkjet ink, a UV ink that is cured by irradiation with ultraviolet rays (UV) is known (ref. e.g. JP-A-2003-221528 (JP-A denotes a Japanese unexamined patent application publication)). When such an ink is used, curing is normally carried out by a system utilizing radical polymerization of a monomer component, and as the monomer component in this case, an acrylate-based monomer, etc. is generally used (ref. e.g. JP-A-2003-246818, JP-A-2003-292855, JP-A-9-183927).

On the other hand, a technique of imparting surface gloss to an ink has been proposed (ref. JP-A-8-15147 and JP-A-2004-51673). However, these inks are all related to aqueous inks and have poor image robustness and abrasion properties. Furthermore, there is the problem that these inks are not suitable for use with non-absorbing recording materials.

### BRIEF SUMMARY OF THE INVENTION

It is an object of the present invention to provide an inkjet ink composition that enables an image to be formed on various types of recording material with high image robustness and excellent surface gloss, an image formation method that enables a robust, high quality image to be formed stably using the inkjet ink composition, and a recorded material employing the inkjet ink composition.

### Means for Solving the Problems

The objects of the present invention have been accomplished by means described in (1), (12), and (13) below. They are described below together with (2) to (11), which are preferred embodiments.
(1) An inkjet ink composition comprising a polymerizable compound, a photopolymerization initiator, and a metal powder,
(2) the inkjet ink composition according to (1), wherein the metal powder is an aluminum powder,
(3) the inkjet ink composition according to (1) or (2), wherein the metal powder is dispersed in the polymerizable compound,
(4) the inkjet ink composition according to any one of (1) to (3), wherein the metal powder has a volume-average particle size of 5 to 30 μm,
(5) the inkjet ink composition according to any one of (1) to (4), wherein the metal powder has a content of 1 to 30 wt % relative to the total weight of the inkjet ink composition,
(6) the inkjet ink composition according to any one of (1) to (5), wherein it comprises an acidic dispersant,
(7) the inkjet ink composition according to any one of (1) to (6), wherein the metal powder is dispersed by means of a bead mill in the presence of the dispersant and the polymerizable compound,
(8) the inkjet ink composition according to any one of (1) to (7), wherein it has a viscosity at 25° C. of 7 to 120 mPa·s,
(9) the inkjet ink composition according to any one of (1) to (8), wherein the polymerizable compound has a content of at least 50 wt % but no greater than 98 wt % relative to the total weight of the inkjet ink composition,
(10) the inkjet ink composition according to any one of (1) to (9), wherein the polymerizable compound comprises at least one type of oxetane group-containing compound and at least one type of oxirane group-containing compound,
(11) the inkjet ink composition according to any one of (1) to (9), wherein the polymerizable compound comprises at least one type selected from the group consisting of a monofunctional (meth)acrylate and a difunctional (meth)acrylate, and at least one type of tri- or higher-functional (meth)acrylate compound,
(12) an image formation method comprising an image recording step of recording an image on a recording material by inkjet recording in which the inkjet ink composition according to any one of (1) to (11) is discharged, and an image curing step of curing the image recorded on the recording material in the image recording step by irradiation with actinic radiation, and
(13) a recorded material formed by using the inkjet ink composition according to any one of (1) to (11).

### DETAILED DESCRIPTION OF THE INVENTION

The inkjet ink composition of the present invention, and the image formation method and the recorded material employing same are explained in detail below.

### Inkjet Ink composition

The inkjet ink composition of the present invention (in the present invention, also called simply an ink or an ink composition) comprises (A) a polymerizable compound, (B) a photopolymerization initiator, and (C) a metal powder.

Since the inkjet ink composition of the present invention comprises a polymerizable compound, a photopolymerization initiator, and a metal powder, after the ink is discharged it may be cured by irradiation with ultraviolet rays, etc. Because of this, an image can be formed on various types of recording material, such as a non-absorbing recording material (recording medium). Furthermore, since an image formed using the inkjet ink composition of the present invention has excellent image robustness, such as abrasion properties, it is possible to prevent cracking, etc. of the ink, thereby improving the surface gloss of the image formed.

Moreover, the ink composition of the present invention may be constituted so as to contain substantially no volatile solvent. Because of this, unlike an aqueous ink or a solvent ink, there are no problems such as nozzle clogging caused by an increase in viscosity, etc. due to evaporation of water or solvent, and the ink discharge properties are excellent. Furthermore, since the inkjet ink composition of the present invention comprises a metal powder, an image obtained by curing the ink composition has surface gloss.

The inkjet ink composition of the present invention is constituted so that, after an image is recorded on a recording material, the recorded image can be cured by irradiation with actinic radiation, etc. Furthermore, the inkjet ink composition of the present invention comprises a polymerizable compound, a photopolymerization initiator, and a metal powder, and may comprise as necessary other components such as various types of additive. It is preferable for the inkjet ink composition of the present invention to employ as an additive (D) a dispersant, and it is particularly preferable to employ an acidic dispersant. A detailed explanation is given below.

### (A) Polymerizable Compound

The polymerizable compound used in the present invention is not particularly limited as long as it is a compound that undergoes a polymerization reaction due to an active species generated from a polymerization initiator such as a photopolymerization initiator and is cured, and a radically polymerizable compound or a cationically polymerizable compound may be used.

The radically polymerizable compound and the cationically polymerizable compound are explained below.

### Radically Polymerizable Compound

The radically polymerizable compound is a compound having a radically polymerizable ethylenically unsaturated bond; it may be any compound as long as it has at least one radically polymerizable ethylenically unsaturated bond in the molecule, and includes those with the chemical configuration of monomer, oligomer, polymer, etc. Such a radically polymerizable compound may be used singly or in a combination of two or more types in any ratio in order to improve desired properties. It is more preferable to use a polyfunctional compound having two or more functional groups than it is to use a monofunctional compound. Moreover, it is preferable to use two or more types of polyfunctional compound in combination in terms of the reactivity and aspects of the performance such as physical properties being controlled.

In the inkjet ink composition of the present invention, a (meth)acrylate may suitably be used as the radically polymerizable compound. Examples of the (meth)acrylate include the compounds below. In the present invention, among the polymerizable compounds below, it is preferable, from the viewpoint of viscosity adjustment, crosslinking density adjustment, control of physical properties (strength, adhesiveness, etc.) after curing, etc., for the constitution to be such that the composition comprises (a) at least one type of tri- or higher-functional (meth)acrylate, and (b) at least one type selected from a monofunctional (meth)acrylate and a difunctional (meth)acrylate.

Specific examples of the monofunctional (meth)acrylate include hexyl (meth)acrylate, 2-ethylhexyl (meth)acrylate, tert-octyl (meth)acrylate, isoamyl (meth)acrylate, decyl (meth)acrylate, isodecyl (meth)acrylate, stearyl (meth)acrylate, isostearyl (meth)acrylate, cyclohexyl (meth)acrylate, 4-n-butylcyclohexyl (meth)acrylate, bornyl (meth)acrylate, isobornyl (meth)acrylate, benzyl (meth)acrylate, 2-ethylhexyldiglycol (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, an alkoxymethyl (meth)acrylate, an alkoxyethyl (meth)acrylate, 2-(2-methoxyethoxy)ethyl (meth)acrylate, 2-(2-butoxyethoxy)ethyl (meth)acrylate, 2,2,2-trifluoroethyl (meth)acrylate, 1H,1H,2H,2H-perfluorodecyl (meth)acrylate, 4-butylphenyl (meth)acrylate, phenyl (meth)acrylate, 2,4,5-trimethylphenyl (meth)acrylate, 4-chlorophenyl (meth)acrylate, phenoxymethyl (meth)acrylate, phenoxyethyl (meth)acrylate, glycidyl (meth)acrylate, glycidyloxybutyl (meth)acrylate, glycidyloxyethyl (meth)acrylate, glycidyloxypropyl (meth)acrylate, morpholino (meth)acrylate, tetrahydrofurfuryl (meth)acrylate, a hydroxyalkyl (meth)acrylate, 2-hydroxyethyl (meth)acrylate, 3-hydroxypropyl (meth)acrylate, 2-hydroxypropyl (meth)acrylate, 2-hydroxybutyl (meth)acrylate, 4-hydroxybutyl (meth)acrylate, 3-hydroxypropyl (meth)acrylate, dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, oligoethylene oxide monomethyl ether (meth)acrylate, polyethylene oxide (meth)acrylate, oligoethylene oxide (meth)acrylate, an oligoethylene oxide monoalkyl ether (meth)acrylate, a polyethylene oxide monoalkyl ether (meth)acrylate, dipropylene glycol (meth)acrylate, a polypropylene oxide monoalkyl ether (meth)acrylate, an oligopropylene oxide monoalkyl ether (meth)acrylate, 2-methacryloyloxyethylsuccinic acid, 2-methacryloyloxyhexahydrophthalic acid, 2-methacryloyloxyethyl-2-hydroxypropyl phthalate, butoxydiethylene glycol (meth)acrylate, trifluoroethyl (meth)acrylate, perfluorooctylethyl (meth)acrylate, 2-hydroxy-3-phenoxypropyl (meth)acrylate, ethylene oxide-modified phenol (meth)acrylate, ethylene oxide-modified cresol (meth)acrylate, ethylene oxide-modified nonylphenol (meth)acrylate, polyethylene oxide-modified nonylphenol (meth)acrylate, ethylene oxide-modified 2-ethylhexyl (meth)acrylate, carbitol (meth)acrylate, an oligoester (meth)acrylate, epoxy (meth)acrylate, urethane (meth)acrylate, methyl (meth)acrylate, n-butyl (meth)acrylate, 2-ethylhexyl (meth)acrylate, lauryl (meth)acrylate, allyl (meth)acrylate, glycidyl (meth)acrylate, benzyl (meth)acrylate, and dimethylaminomethyl (meth)acrylate.

Specific examples of the difunctional (meth)acrylate include dipropylene glycol di(meth)acrylate, dimethyloldicyclopentane di(meth)acrylate, 1,9-nonanediol di(meth)acrylate, 1,6-hexanediol di(meth)acrylate, 1,10-decanediol di(meth)acrylate, neopentyl glycol di(meth)acrylate, 2,4-dimethyl-1,5-pentanediol di(meth)acrylate, ethoxylated cyclohexanedimethanol di(meth)acrylate, polyethylene glycol di(meth)acrylate, oligoethylene glycol di(meth)acrylate, ethylene glycol di(meth)acrylate, 2-ethyl-2-butylbutanediol di(meth)acrylate, neopentyl glycol hydroxypivalate di(meth)acrylate, ethylene oxide-modified bisphenol A di(meth)acrylate, ethylene oxide-modified bisphenol F di(meth)acrylate, polypropylene glycol di(meth)acrylate, oligopropylene glycol di(meth)acrylate, 1,4-butanediol di(meth)acrylate, 2-ethyl-2-butylpropanediol di(meth)acrylate, 1,9-nonane di(meth)acrylate, propoxylated ethoxylated bisphenol A di(meth)acrylate, tricyclodecane di(meth)acrylate, diethylene glycol di(meth)acrylate, triethylene glycol di(meth)acrylate, tetraethylene glycol di(meth)acrylate, ethylene glycol di(meth)acrylate, and triethylene glycol di(meth)acrylate.

Specific examples of the trifunctional (meth)acrylate include trimethylolpropane tri(meth)acrylate, trimethylolethane tri(meth)acrylate, an alkylene oxide-modified tri(meth)acrylate of trimethylolpropane, pentaerythritol tri(meth)acrylate, dipentaerythritol tri(meth)acrylate, trimethylolpropane tri((meth)acryloyloxypropyl)ether, an isocyanuric acid alkylene oxide-modified tri(meth)acrylate, propionic acid dipentaerythritol tri(meth)acrylate, tri((meth)acryloyloxyethyl)isocyanurate, hydroxypivalaldehyde-modified dimethylolpropane tri(meth)acrylate, sorbitol tri(meth)acrylate, propoxylated trimethylolpropane tri(meth)acrylate, and ethoxylated glycerol triacrylate.

Specific examples of tetrafunctional (meth)acrylates include pentaerythritol tetra(meth)acrylate, sorbitol tetra(meth)acrylate, ditrimethylolpropane tetra(meth)acrylate, dipentaerythritol propionate tetra(meth)acrylate, ethoxylated pentaerythritol tetra(meth)acrylate, dipentaerythritol tetra(meth)acrylate, and tetramethylolmethane tetra(meth)acrylate.

Specific examples of pentafunctional (meth)acrylates include sorbitol penta(meth)acrylate and dipentaerythritol penta(meth)acrylate.

Specific examples of hexafunctional (meth)acrylates include dipentaerythritol hexa(meth)acrylate, sorbitol hexa(meth)acrylate, an alkylene oxide-modified hexa(meth)acrylate of phosphazene, caprolactone-modified dipentaerythritol hexa(meth)acrylate, and ethoxylated dipentaerythritol hexaacrylate.

The above-mentioned notation ‘(meth)acrylate’ denotes that it can take either an acrylate structure or a methacrylate structure.

Examples of the radically polymerizable compound other than the above-mentioned compounds include unsaturated carboxylic acids such as acrylic acid, methacrylic acid, itaconic acid, crotonoic acid, isocrotonoic acid, and maleic acid, and salts thereof, anhydrides, acrylonitrile, styrene, and various types of radically polymerizable compounds such as unsaturated polyesters, unsaturated polyethers, unsaturated polyamides, and unsaturated urethanes.

Specific examples thereof include acrylic acid derivatives such as bis(4-acryloxypolyethoxyphenyl)propane, and diacetone acrylamide; methacrylic acid derivatives such as 2,2-bis(4-methacryloxypolyethoxyphenyl)propane; and allyl compound derivatives such as allyl glycidyl ether, diallyl phthalate, and triallyl trimellitate. More specifically, commercial products, radically polymerizable or crosslinking monomers, oligomers, and polymers known in the art such as those described in ‘Kakyozai Handobukku’ (Crosslinking Agent Handbook), Ed. S. Yamashita (Taiseisha, 1981); ‘UV•EB Koka Handobukku’ (UV•EB Curing Handbook (Starting Materials) Ed. K. Kato (Kobunshi Kankoukai, 1985); ‘UV•EB Koka Gijutsu no Oyo to Shijyo’ (Application and Market of UV•EB Curing Technology’, p. 79, Ed. Rad Tech (CMC, 1989); and E. Takiyama ‘Poriesuteru Jushi Handobukku’ (Polyester Resin Handbook), (The Nikkan Kogyo Shimbun Ltd., 1988) can be used.

### Cationically Polymerizable Compound

As the cationically polymerizable compound, various types of cationically polymerizable monomers known as photo-cationically polymerizable monomers may be used. Examples of the cationically polymerizable monomer include vinyl ether compounds, oxetane compounds and oxirane compound described in JP-A-6-9714, JP-A-2001-31892, JP-A-2001-40068, JP-A-2001-55507, JP-A-2001-310938, JP-A-2001-310937, JP-A-2001-220526, etc.

Examples of the vinyl ether compounds include di- or tri-vinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether, and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl vinyl ether, dodecyl vinyl ether, diethylene glycol monovinyl ether, and octadecyl monovinyl ether.

As the vinyl ether compound, the di- or tri-vinyl ether compounds are preferable from the viewpoint of curability, adhesion to a recording medium, surface hardness of the image formed, etc., and the divinyl ether compounds are particularly preferable.

### Oxetane Group-Containing Compound/Oxirane Group-Containing Compound

In particular, the inkjet ink composition of the present invention preferably comprises as the polymerizable compound at least one type of oxetane group-containing compound and/or at least one type of oxirane group-containing compound, and more preferably at least one type of oxetane group-containing compound and at least one type of oxirane group-containing compound. These compounds are preferable since they polymerize and self-cure by the action of a photopolymerization initiator, which will be described later, when irradiated with actinic radiation and, moreover, since the curing reaction can be carried out in a short time a high quality image can be formed on non-absorbing and absorbing recording materials.

When the oxetane group-containing compound (p) and the oxirane group-containing compound (q) are used in combination, the content ratio p/q is preferably in the range of 50/50 to 95/5 from the viewpoint of the surface gloss and the abrasion resistance of a cured image being improved more effectively, and is particularly preferably in the range of 67/33 to 90/10.

### Oxetane Group-Containing Compound

The oxetane group-containing compound may be selected appropriately from compounds containing at least one oxetane group (oxetanyl group) in the molecule.

For example, as a compound having one oxetane group in the molecule, a compound represented by Formula (1-a) below is suitable, and as a compound having two or more oxetane groups in the molecule, a compound represented by Formula (1-b) below is suitable.

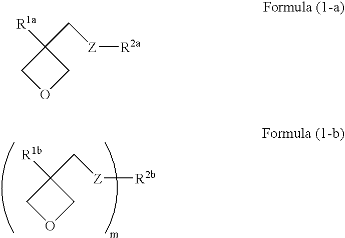

The oxetane group-containing compound represented by Formula (1-a) is now explained.

In Formula (1-a) above, Z denotes an oxygen atom or a sulfur atom, and is preferably an oxygen atom. R^{1a} denotes a hydrogen atom, a fluorine atom, an alkyl group having 1 to 6 carbons (e.g. methyl, ethyl, propyl, butyl, etc.), a fluoroalkyl group having 1 to 6 carbons, an allyl group, an aryl group, a furyl group, or a thienyl group, and is preferably an alkyl group having 1 to 6 carbons (in particular, methyl or ethyl).

R^{2a} denotes a hydrogen atom, an alkyl group having 1 to 6 carbons (e.g. methyl, ethyl, propyl, butyl, etc.), an alkenyl group having 1 to 6 carbons (e.g. 1-propenyl, 2-propenyl, 2-methyl-I-propenyl, 2-methyl-2-propenyl, 1-butenyl, 2-butenyl, 3-butenyl, etc.), an aryl group (e.g. phenyl, benzyl, fluorobenzyl, methoxybenzyl, phenoxyethyl, etc.), an alkylcarbonyl group having 1 to 6 carbons (e.g. propylcarbonyl, butylcarbonyl, pentylcarbonyl, etc.), an alkoxycarbonyl group having 1 to 6 carbons (e.g. ethoxycarbonyl, propoxycarbonyl, butyloxycarbonyl, etc.), or an alkoxycarbamoyl group having 1 to 6 carbons (e.g. ethoxycarbamoyl, propoxycarbamoyl, butylcarbamoyl, pentyloxycarbamoyl, etc.).

Among the oxetane group-containing compounds represented by Formula (1-a) above, a form in which R^{1a} is a lower alkyl group (in particular, ethyl), R^{2a} is a hydrogen atom, a butyl group, a phenyl group, or a benzyl group, and Z is an oxygen atom is particularly preferable. The lower alkyl group referred to here means an alkyl group having 1 to 3 carbons (the same applies below).

The oxetane group-containing compound represented by Formula (1-a) above may be used singly or in a combination of two or more types.

The oxetane group-containing compound represented by Formula (1-b) is now explained.

In Formula (1-b) above, m denotes 2, 3, or 4, the m Zs independently denote an oxygen atom or a sulfur atom, and the Zs are preferably oxygen atoms.

In Formula (1-b) above, the m R^{1b}s independently denote a hydrogen atom, a fluorine atom, an alkyl group having 1 to 6 carbons (e.g. methyl, ethyl, propyl, butyl, etc.), a phenyl group, a fluoroalkyl group having 1 to 6 carbons, an allyl group, an aryl group, or a furyl group.

R^{2b} denotes a linear or branched alkylene group having 1 to 12 carbons or a linear or branched poly(alkyleneoxy) group, or denotes a divalent group selected from the group consisting of Formulae (3), (4), and (5) below.

The linear or branched alkylene group having 1 to 12 carbons is preferably a group represented by Formula (2) below. R³ in Formula (2) below denotes a lower alkyl group such as a methyl group, an ethyl group, or a propyl group.

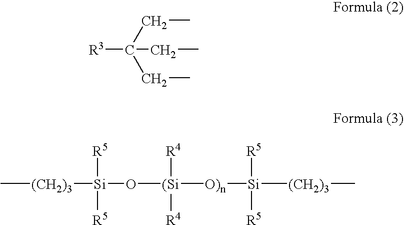

In Formula (3) above, n denotes an integer of 0 or 1 to 2,000, and R⁴ denotes an alkyl group having 1 to 10 carbons (e.g. methyl, ethyl, propyl, butyl, pentyl, hexyl, heptyl, octyl, nonyl, etc.), or a group selected from groups represented by Formula (6) below. R⁵ denotes an alkyl group having 1 to 10 carbons (e.g. methyl, ethyl, propyl, butyl, pentyl, hexyl, heptyl, octyl, nonyl, etc.), and is preferably a methyl group.

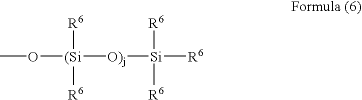

In Formula (6) above, j denotes an integer of 0 or 1 to 100, and R⁶ denotes an alkyl group having 1 to 10 carbons (e.g. methyl, ethyl, propyl, butyl, pentyl, hexyl, heptyl, octyl, nonyl, etc.), and is preferably a methyl group.

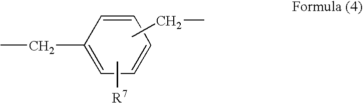

In Formula (4) above, R⁷ denotes a hydrogen atom, an alkyl group having 1 to 10 carbons (e.g. methyl, ethyl, propyl, butyl, pentyl, hexyl, heptyl, octyl, nonyl, etc.), an alkoxy group having 1 to 10 carbons (e.g. methoxy, ethoxy, propoxy, butoxy, pentoxy, etc.), a halogen atom (e.g. fluorine, chlorine, bromine, iodine, etc.), a nitro group, a cyano group, a mercapto group, an alkoxycarbonyl group (e.g. methyloxycarbonyl, ethyloxycarbonyl, butyloxycarbonyl, etc.), or a carboxyl group.

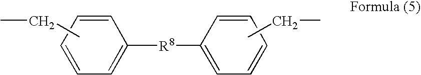

In Formula (5) above, R⁸ denotes an oxygen atom, a sulfur atom, NH, SO, SO₂, CH₂, C(CH₃)₂, or C(CF₃)₂.

Among the oxetane group-containing compounds represented by Formula (1-b) above, a form is preferable in which R^{1b} in Formula (1-b) denotes a lower alkyl group (e.g. methyl, ethyl, propyl, etc.) and, in particular, an ethyl group; R^{2b} is a group represented by Formula (4) with R⁷ being a hydrogen atom or a hexamethylene group, a group represented by Formula (2) with R³ being an ethyl group, or a group represented by Formula (3) with R⁵ being a methyl group and R⁴ being represented by Formula (6) with R⁶ being a methyl group; Z is an oxygen atom; and m is 2.

Furthermore, as the compound having two or more oxetane groups in the molecule, a compound represented by Formula (7) or (8) can be cited.

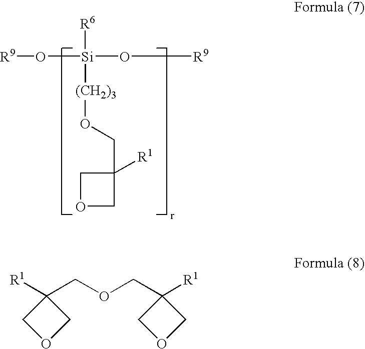

In Formula (7) above, r denotes an integer of 25 to 200, and R⁹ denotes an alkyl group having 1 to 4 carbons or a trialkylsilyl group. R¹ in Formula (7) and Formula (8) and R⁶ in Formula (7) have the same meanings as R^{1b} in Formula (1-b) above and R⁶ in Formula (6) above respectively.

Preferred specific examples of the oxetane group-containing compound are listed below (Compound Examples 1 to 37 and (a) to (f)). However, the present invention should not be construed as being limited thereto.

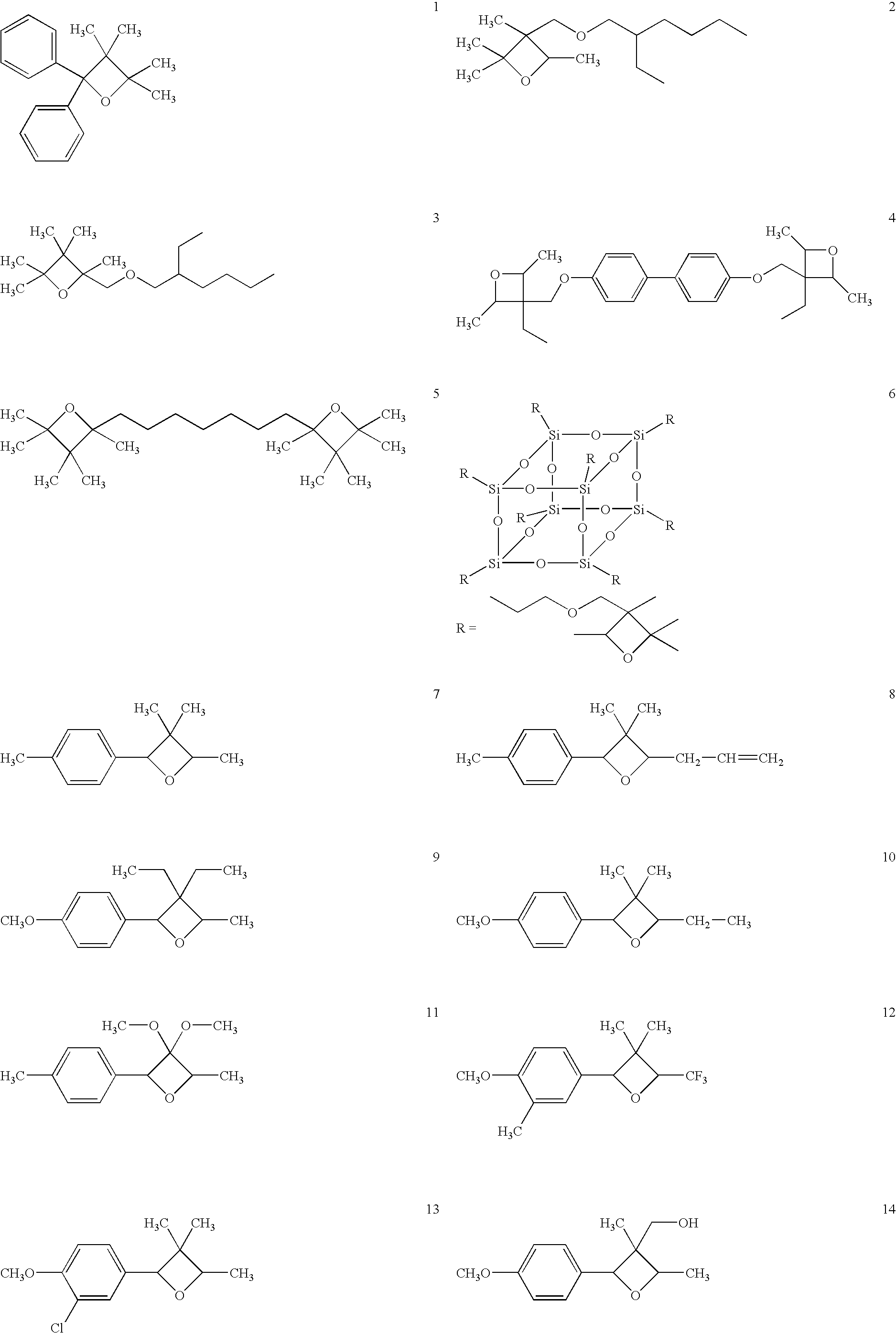

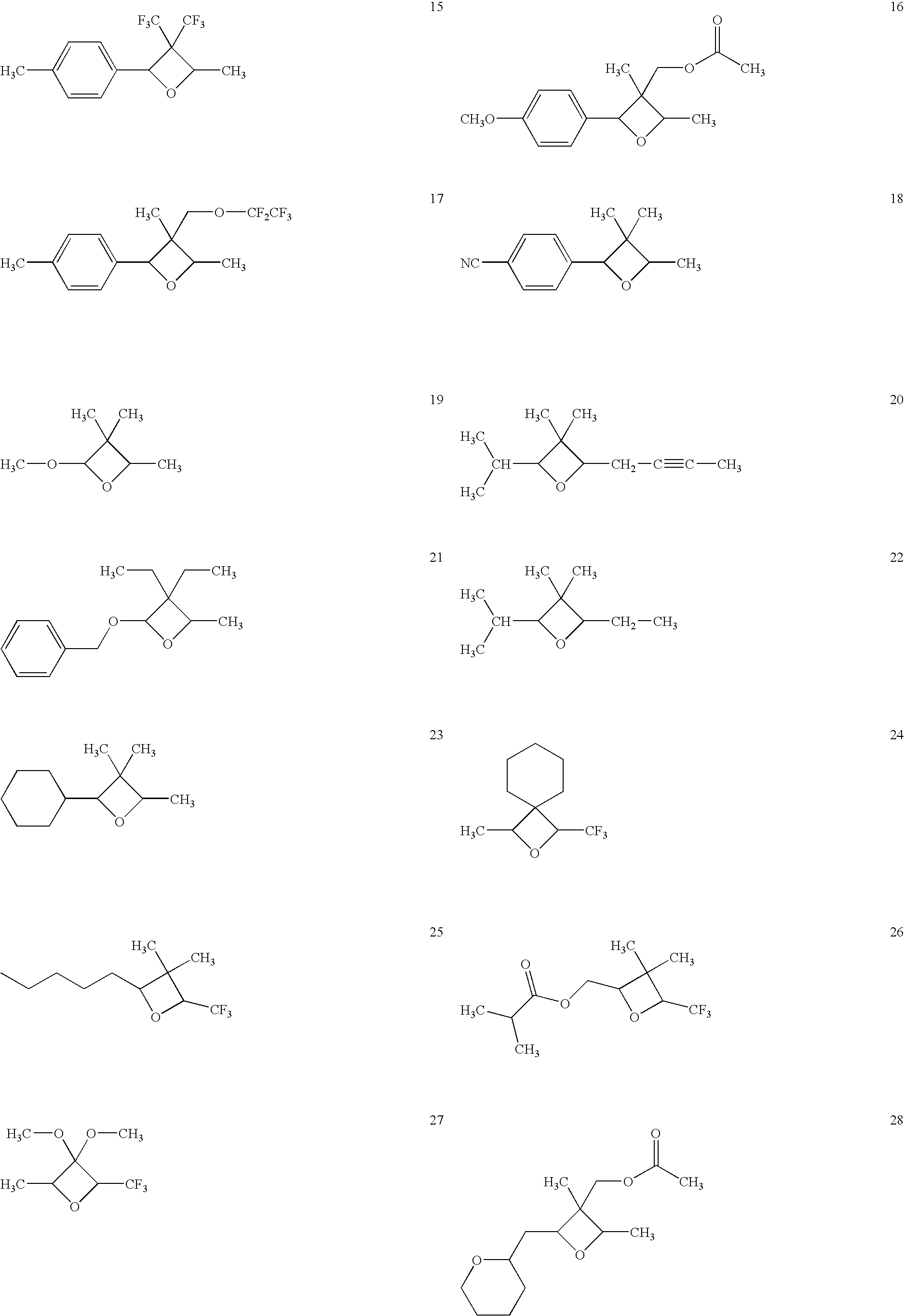

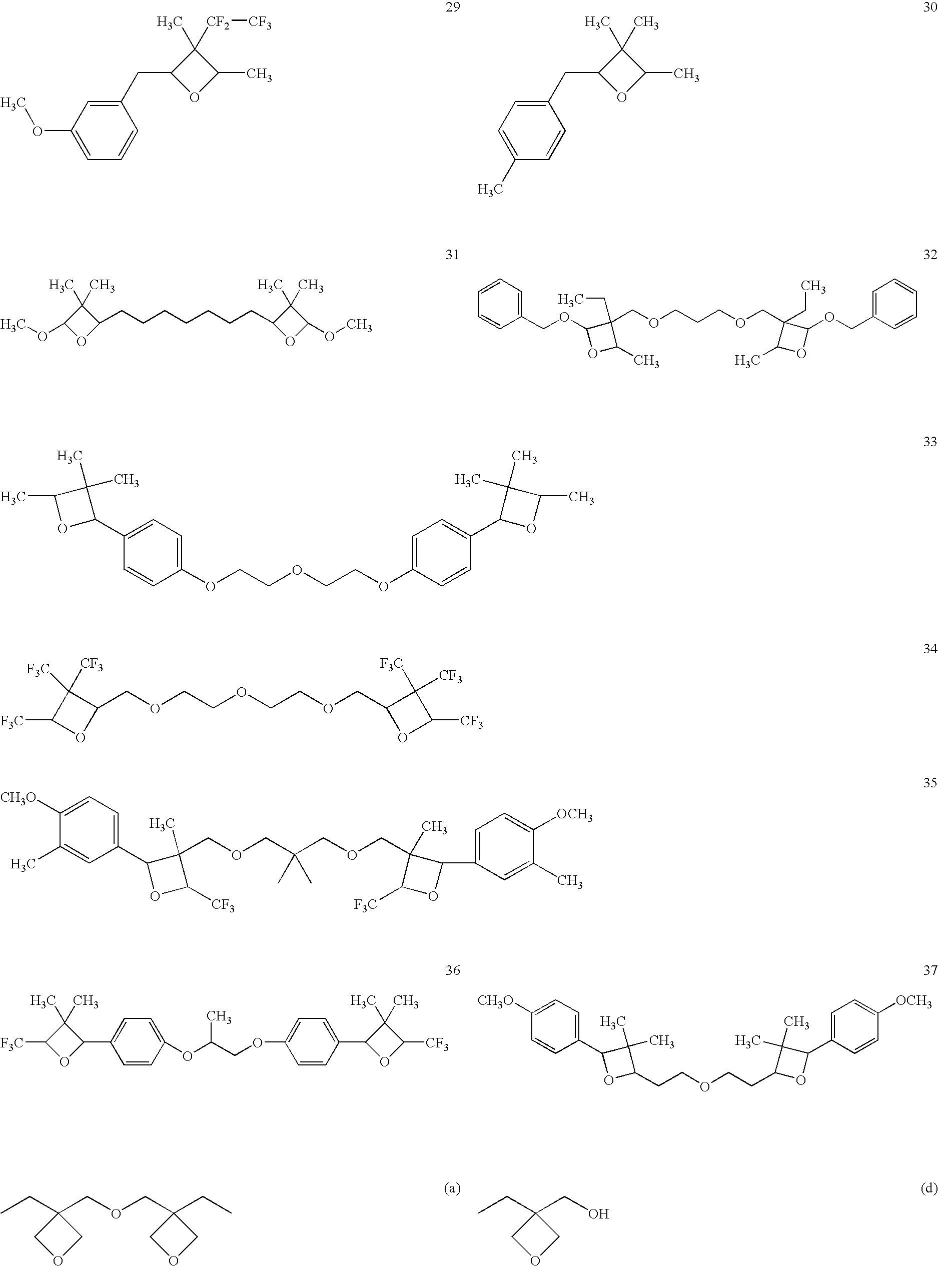

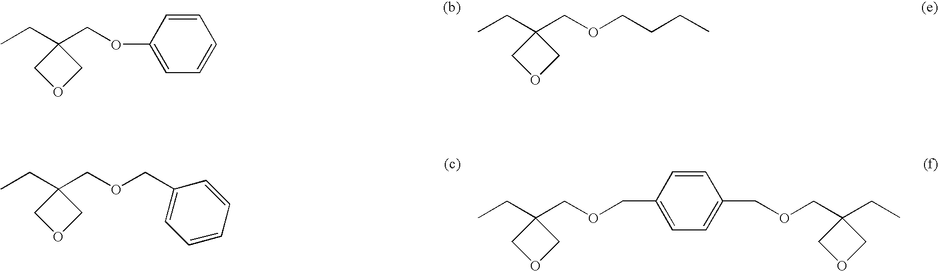

The oxetane group-containing compound may be synthesized by referring to (1) H. A. J. Curless, “Synthetic Organic Photochemistry”, Plenum, New York (1984), (2) M. Braun, Nachr. Chem. Tech. Lab., 33, 213 (1985), (3) S. H. Schroeter, J. Org. Chem., 34, 5, 1181 (1969), (4) D. R. Arnold, Adv. Photochem., 6, 301 (1968), (5) “Heterocyclic Compounds with Three- and Four-membered Rings”, Part Two, Chapter IX, Interscience Publishers, John Wiley & Sons, New York (1964), (6) Bull. Chem. Soc. Jpn., 61, 1653 (1988), (7) Pure Appl. Chem., A29 (10), 915 (1992), (8) Pure Appl. Chem., A30 (2 & 3), 189 (1993), (9) JP-A-6-16804, (10), German Patent No. 1,021,858, etc.

The oxetane group-containing compound represented by Formula (1-b) above may be used singly or in a combination of two or more types.

Among the oxetane group-containing compounds above, Compound Example (a), Compound Example (b), Compound Example (d), and Compound Example (f) are particularly preferable.

### Oxirane Group-Containing Compound

The oxirane group-containing compound is an oxirane ring-containing compound below having in the molecule at least one oxirane group (oxiranyl group); specifically, it may be selected from those normally used as an epoxy resin, and may be any one of a monomer, an oligomer, and a polymer.

Specific examples of the oxirane group-containing compound include conventionally known aromatic epoxy resins, alicyclic epoxy resins, and aliphatic epoxy resins. The epoxy resin referred to here means a monomer, an oligomer, or a polymer.

Preferred examples of the aromatic epoxy resins include di- or poly-glycidyl ethers produced by a reaction between epichlorohydrin and a polyhydric phenol having at least one aromatic nucleus or an alkylene oxide adduct thereof. Specific examples thereof include di- or poly-glycidyl ethers of bisphenol A or an alkylene oxide adduct thereof, di- or poly-glycidyl ethers of hydrogenated bisphenol A or an alkylene oxide adduct thereof, and novolac type epoxy resins. Examples of the alkylene oxide above include ethylene oxide and propylene oxide.

Preferred examples of the alicyclic epoxy resins include cyclohexene oxide- and cyclopentene oxide-containing compounds obtained by epoxidizing a compound having at least one cycloalkene ring such as a cyclohexene ring or a cyclopentene ring with an appropriate oxidizing agent such as hydrogen peroxide or a peracid. Specific examples thereof include (3′,4′-epoxycyclohexane)methyl-3,4,-epoxycyclohexane carboxylate.

Preferred examples of the aliphatic epoxides include di- or poly-glycidyl ethers of an aliphatic polyhydric alcohol or an alkylene oxide adduct thereof. Specific examples thereof include diglycidyl ethers of an alkylene glycol such as the diglycidyl ether of ethylene glycol, the diglycidyl ether of propylene glycol, and the diglycidyl ether of 1,6-hexanediol, polyglycidyl ethers of a polyhydric alcohol such as the di- or tri-glycidyl ether of glycerol or an alkylene oxide adduct thereof, and diglycidyl ethers of a polyalkylene glycol such as the diglycidyl ether of polyethylene glycol or an alkylene oxide adduct thereof and the diglycidyl ether of polypropylene glycol or an alkylene oxide adduct thereof. Examples of the alkylene oxide above include ethylene oxide and propylene oxide.

As the oxirane group-containing compound, in addition to the above-mentioned compounds, there can be cited a monoglycidyl ether of a higher aliphatic alcohol, a monoglycidyl ether of phenol, cresol, an alkylene oxide adduct thereof, etc., which are monomers having one oxirane ring in the molecule.

The oxirane group-containing compound may be used singly or in a combination of two or more types.

Preferred specific examples of the oxirane group-containing compound are listed below (Compound Examples (i) to (viii)). However, the present invention should not be construed as being limited thereto.

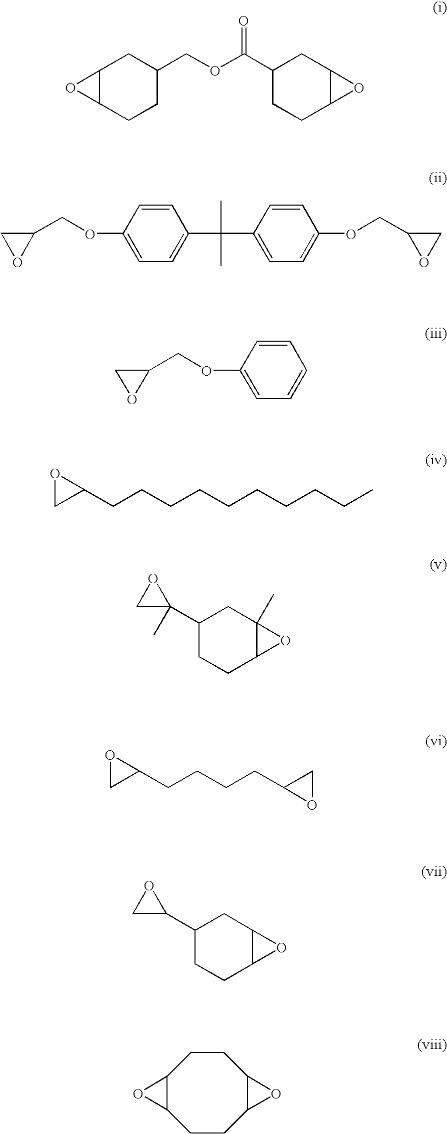

Among the oxirane group-containing compounds, Compound Example (i) and Compound Example (v) above are particularly preferable.

In the present invention, it is preferable to use the above-mentioned oxetane group-containing compound and oxirane group-containing compound in combination, and as a form of the combination, for example, a combination of Compound Example (a) and Compound Example (i) and a combination of Compound Example (b) and Compound Example (v) are particularly preferable in terms of the surface gloss being improved more effectively.

The content of the polymerizable compound in the inkjet ink composition of the present invention is preferably 98 to 50 wt % relative to the total amount (total weight) of the ink composition from the viewpoint of sensitivity due to polymerization reactivity and the viscosity of the ink composition, is more preferably 95 to 60 wt %, and is yet more preferably 90 to 70 wt %.

### (B) Photopolymerization Initiator

The inkjet ink composition of the present invention comprises at least one type of photopolymerization initiator in order to polymerize and cure the polymerizable compound. The photopolymerization initiator has an absorption in the wavelength region of actinic radiation, and can act on the above-mentioned polymerizable compound when exposed to actinic radiation, thus promoting the polymerization and curing thereof.

The photopolymerization initiator is a compound that undergoes a chemical change by the action of actinic radiation or via interaction with an electronically excited state of a sensitizing dye and generates at least one of a radical, an acid, and a base. Specifically, it includes an initiator that generates an active radical species by the application of actinic radiation to thus initiate and promote polymerization and curing of a polymerizable compound (i.e. an ink composition) and an initiator that generates a cationic species by the application of actinic radiation to similarly initiate and promote polymerization and curing of a polymerizable compound (i.e. an ink composition), and it may be selected appropriately from the polymerization initiators below.

In the present invention, the ‘actinic radiation’ referred to is actinic radiation that generates a radical or a cation from a photopolymerization initiator, and includes ultraviolet rays (UV light), visible light, γ rays, α rays, X rays, and an electron beam. Specific examples of a light source that can be used include an LD, an LED, a fluorescent lamp, a low pressure mercury lamp, a high pressure mercury lamp, a metal halide lamp, a carbon arc lamp, a xenon lamp, and a chemical lamp. Preferred examples of the light source include an LED, a high pressure mercury lamp, and a metal halide lamp.

As the photopolymerization initiator, initiators known by a person skilled in the art may be used without limitation. Specifically, those described in Bruce M. Monroe et al., Chemical Reviews, 93, 435 (1993), R. S. Davidson, Journal of Photochemistry and Biology A: Chemistry, 73. 81 (1993), J. P. Faussier “Photoinitiated Polymerization-Theory and Applications”: Rapra Review Vol. 9, Report, Rapra Technology (1998), and M. Tsunooka et al., Prog. Polym. Sci., 21, 1 (1996) can be cited. Furthermore, compounds described as compounds used for chemically amplified photoresists or cationic photopolymerization in ‘Imejingu you Yukizairyou’ (Organic Materials for Imaging) (Ed. The Japanese Research Association for Organic Electronics Materials, Bunshin Publishing Co. (1993), pp. 187-192) can be cited. Moreover, a group of compounds that undergo oxidative or reductive bond cleavage via interaction with an electronically excited state of a sensitizing dye, described in F. D. Saeva, Topics in Current Chemistry, 156, 59 (1990), G. G. Maslak, Topics in Current Chemistry, 168, 1 (1993), H. B. Shuster et al., JACS, 112, 6329 (1990), I. D. F. Eaton et al., JACS, 102, 3298 (1980), etc., can also be cited.

Preferred examples of the radical polymerization initiator that can be used in the present invention include (a) an aromatic ketone, (b) an aromatic onium salt compound, (c) an organic peroxide, (d) a hexaarylbiimidazole compound, (e) a ketoxime ester compound, (f) a borate compound, (g) an azinium compound, (h) a metallocene compound, (i) an active ester compound, and (j) a compound having a carbon-halogen bond.

Preferred examples of the aromatic ketone (a) include a compound having a benzophenone skeleton or a compound having a thioxanthone skeleton described in ‘RADIATION CURING IN POLYMER SCIENCE AND TECHNOLOGY’ J. P. FOUASSIER, J. F. RABEK (1993), pp. 77 to 117. Preferred examples of the aromatic ketone include an a-thiobenzophenone compound described in JP-B-47-6416, a benzoin ether compound described in JP-B-47-3981, an a-substituted benzoin compound described in JP-B-47-22326, a benzoin derivative described in JP-B-47-23664, an aroylphosphonic acid ester described in JP-A-57-30704, a dialkoxybenzophenone described in JP-B-60-26483, benzoin ethers described in JP-B-60-26403 and JP-A-62-81345, a-aminobenzophenones described in JP-B-1-34242, US Pat. No. 4,318,791, and EP No. 0284561A1, p-di(dimethylaminobenzoyl)benzene described in JP-A-2-211452, a thio-substituted aromatic ketone described in JP-A-61-194062, an acylphosphine sulfide described in JP-B-2-9597, an acylphosphine described in JP-B-2-9596, a thioxanthone described in JP-B-63-61950, and a coumarin described in JP-B-59-42864.

As the aromatic onium salt compound (b), there can be cited aromatic onium salts of elements of Groups VB, VIB, and VIIB of the periodic table, specifically, N, P, As, Sb, Bi, O, S, Se, Te, and I. Examples thereof include iodonium salts described in EP No. 104143, U.S. Pat. No, 4837124, JP-A-2-150848, and JP-A-2-96514, sulfonium salt and diazonium salts (optionally substituted benzenediazoniums, etc.) described in EP Nos. 370693, 233567, 297443, 297442, 279210, and 422570, US Pat. Nos. 3902144, 4933377, 4760013, 4734444, and 2833827, diazonium salt resins (diazodiphenylamine formaldehyde resins, etc.), N-alkoxypyridinium salts, etc. (e.g. those described in U.S. Pat. No. 4,743,528, JP-A-63-138345, JP-A-63-142345, JP-A-63-142346, and JP-B-46-42363; specific examples thereof include 1-methoxy-4-phenylpyridinium tetrafluoroborate); furthermore, compounds described in JP-B-52-147277, 52-14278, and 52-14279 may suitably be used. A radical or an acid is formed as an active species.

As the organic peroxide (c), almost all organic compounds having at least one oxygen-oxygen bond per molecule can be cited, and preferred examples thereof include peroxide ester compounds such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, and di-t-butyidiperoxyisophthalate.

As the hexaarylbiimidazole compound (d), there can be cited lophine dimers described in JP-B-45-37377 and JP-B-44-86516, and examples thereof include 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,55,5′-tetraphenylbiimidazole, 2,2′-bis(o-methylphenyl)-4,4′,5,5′-tetraphenylbiimidazole, and 2,2′-bis(o-trifluorophenyl)-4,4′,5,5′-tetraphenylbiimidazole.

As the ketoxime ester compound (e), there can be cited 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-p-toluenesulfonyloxyiminobutan-2-one, and 2-ethoxycarbonyloxyimino-1-phenylpropan-1-one.

Examples of the borate compound (f) include compounds described in U.S. Pat. Nos. 3,567,453 and 4,343,891, and EP Nos. 109,772 and 109,773.

Examples of the azinium salt compound (g) include N-O bond-containing compounds described in JP-A-63-138345, JP-A-63-142345, JP-A-63-142346, JP-A-63-143537, and JP-B-46-42363.

Examples of the metallocene compound (h) include titanocene compounds described in JP-A-59-152396, JP-A-61-151197, JP-A-63-41484, JP-A-2-249, and JP-A-2-4705, and iron-arene complexes described JP-A-1-304453 and JP-A-1-152109.

Specific examples of the titanocene compound include dicyclopentadienyl-Ti-dichloride, dicyclopentadienyl-Ti-bis-phenyl, di-cyclopentadienyl-Ti-bis-2,3,4,5,6-pentafluorophen-1-yl, dicyclopentadienyl-Ti-bis-2,3,5,6-tetrafluorophen-1-yl, dicyclopentadienyl-Ti-bis-2,4,6-trifluorophen-1-yl, dicyclopentadienyl-Ti-2,6-difluorophen-1-yl, dicyclopentadienyl-Ti-bis-2,4-difluorophen-1-yl, dimethylcyclopentadienyl-Ti-bis-2,3,4,5,6-pentafluorophen-1-yl, dimethylcyclopentadienyl-Ti-bis-2,3,5,6-tetrafluorophen-1-yl, dimethylcyclopentadienyl-Ti-bis-2,4-difluorophen-1-yl, bis(cyclopentadienyl)-bis(2,6-difluoro-3-(pyrr-1-yl)phenyl)titanium, bis(cyclopentadienyl)bis[2,6-difluoro-3-(methylsulfonamido)phenyl]titanium, and bis(cyclopentadienyl)bis[2,6-difluoro-3-(N-butylbiaroylamino)phenyl]titanium.

Examples of the active ester compound (i) include nitrobenzyl ester compounds described in EP Nos, 0290750, 046083, 156153, 271851, and 0388343, U.S. Pat. Nos. 3901710 and 4181531, JP-A-60-198538, and JP-A-53-133022, iminosulfonate compounds described in EP Nos. 0199672, 84515, 199672, 044115, and 0101122, US Pat. Nos. 4618564, 4371605, and 4431774, JP-A-64-18143, JP-A-2-245756, and JP-A-4-365048, and compounds described in JP-B-62-6223, JP-B-63-14340, and JP-A-59-174831.

Preferred examples of the compound (j) having a carbon-halogen bond include a compound described in Wakabayashi et. al, Bull. Chem. Soc. Japan, 42, 2924 (1969), a compound described in British Patent No. 1388492, a compound described in JP-A-53-133428, and a compound described in German Patent No. 3337024.

Examples further include a compound described in F. C. Schaefer et al., J. Org. Chem., 29, 1527 (1964), a compound described in JP-A-62-58241, a compound described in JP-A-5-281728, a compound described in German Pat. No. 2641100, a compound described in German Pat. No. 3333450, compounds described in German Pat. No. 3021590, and compounds described in German Pat. No.3021599.

Preferred specific examples of (a) to (j) are listed below.

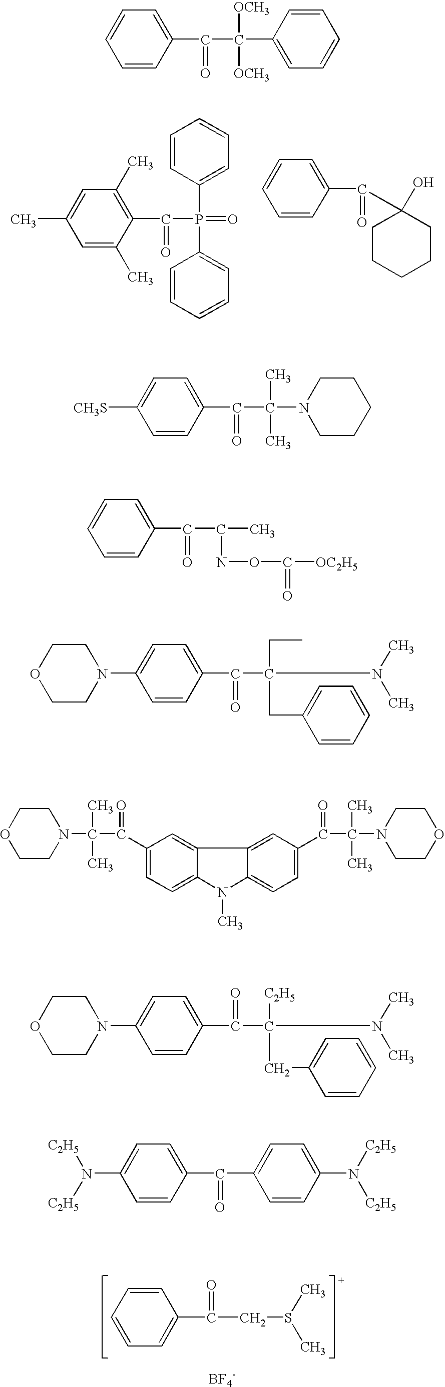

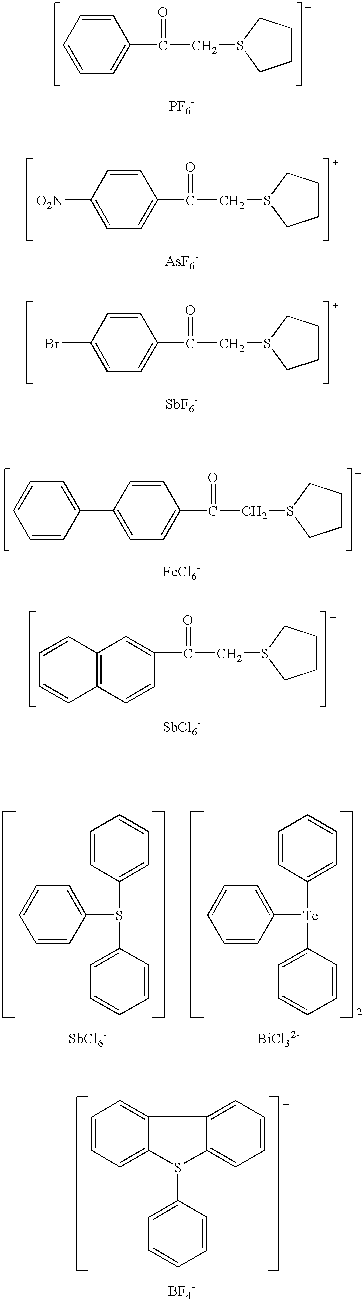

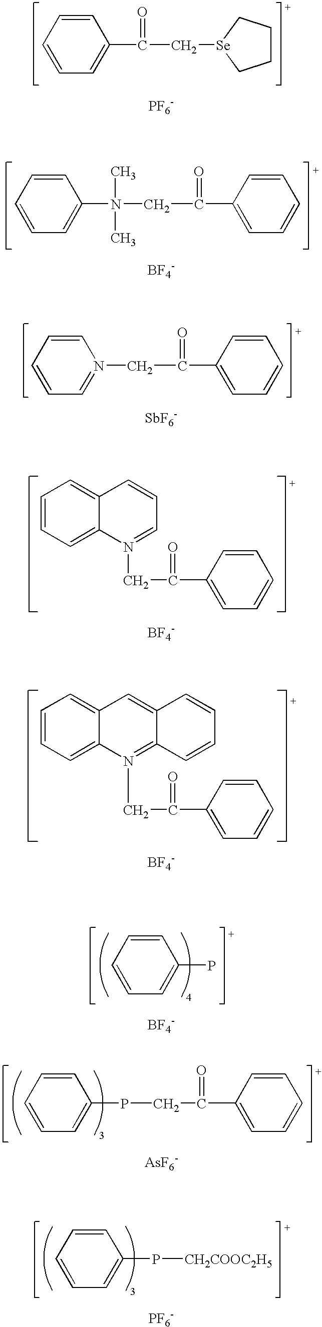

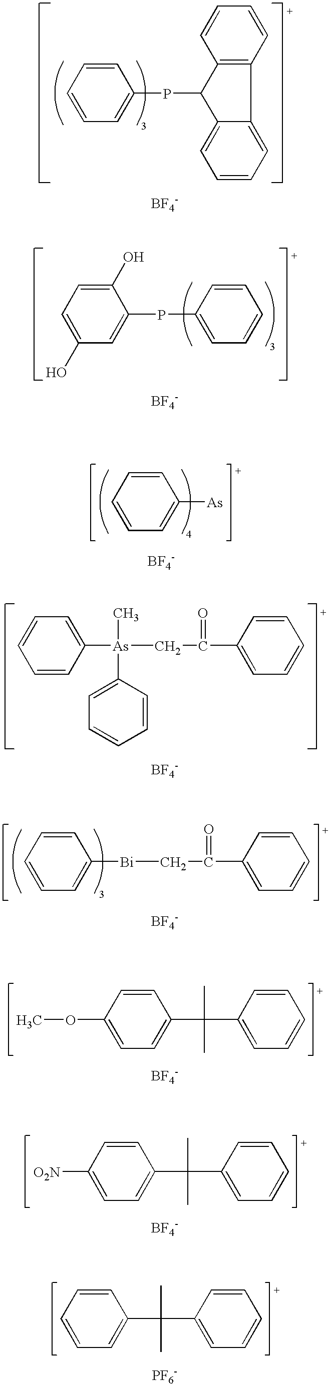

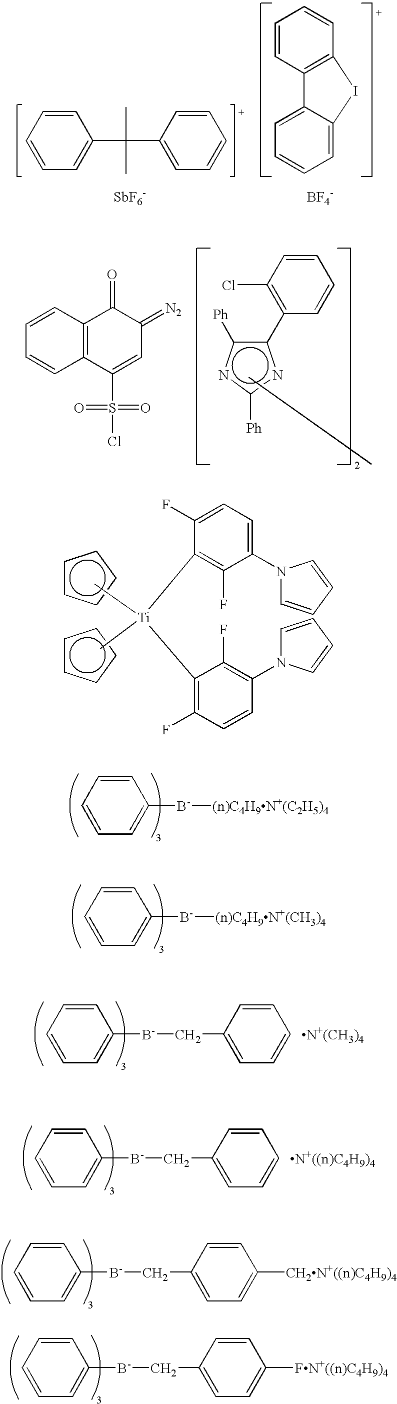

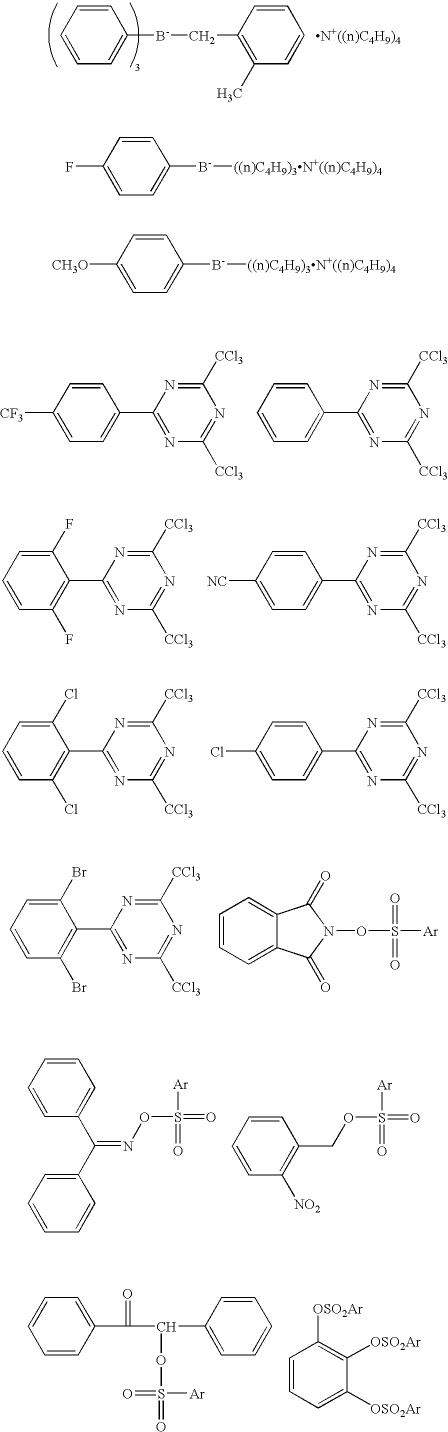

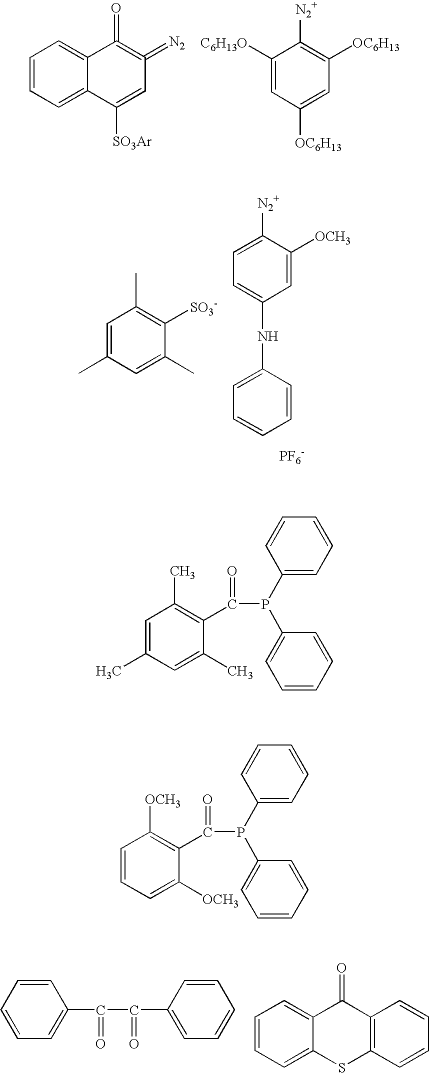

The content of the photopolymerization initiator in the ink composition is preferably in the range of 0.5 to 20 wt % relative to the total amount of the above-mentioned polymerizable compound and the photopolymerization initiator, and more preferably in the range of 1 to 12 wt %. In particular, by making the content be in the above-mentioned range, the curing speed is high, good curability can be obtained, and it is effective in recording a robust image. Furthermore, it is preferable for the content to be in the above-mentioned range since the abrasion resistance is not degraded when the image is rubbed.

### (C) Metal Powder

The inkjet ink composition of the present invention comprises a metal powder. The metal powder here imparts gloss and brightness to the ink composition, and is also called a metal powder pigment.

Any metal powder that can impart gloss and brightness to a recorded material obtained may be used as the metal powder in the present invention, and it is preferable to select it appropriately according to the intended purpose.

Examples of the metal powder include copper powder, aluminum powder, bronze powder, silver powder, and gold powder. The shape of the powder is not particularly limited, but it is particularly preferably fine foil-shaped pieces or scale-shaped, thereby imparting a metallic brightness.

Among them, it is preferable to use an aluminum powder as the metal powder.

As an aluminum powder that can suitably be used as the metal powder pigment, any known aluminum powder may be used by appropriate selection.

The aluminum powder may be produced by any production process. Examples of production processes for aluminum powder include a process involving grinding while rolling an aluminum ingot, a process involving vapor-depositing aluminum on a thin film and powdering it, and a process involving very finely powdering a foil having good brightness, but the present invention is not limited thereto.

Furthermore, the aluminum powder added may be in either paste form or powder form. As a paste-form aluminum powder, a paste in which an aluminum powder is dispersed in a hydrocarbon type solvent (e.g. ethyl acetate) can be cited.

The aluminum powder used in the present invention may be subjected to a surface treatment, etc. For example, an aluminum powder having stearic acid, etc. adsorbed on the surface of the powder can be cited, and when an aluminum powder treated by this method is used, the aluminum powder particles tend to align in parallel to each other on the surface of the discharged ink, thus giving a recorded material having a surface close to a mirror-finished surface.

Furthermore, an aluminum powder coated with a resin can be cited, and this is preferable since the adhesion, chemical resistance, weather resistance, etc. are improved thereby. On the other hand, the surface gloss and the hiding power tend to be poor.

Aluminum powders are commercially available, and examples of a paste-form aluminum powder dispersed in a hydrocarbon type solvent include the ROTOVARIO 500 series (manufactured by Eckart) and ASTROSHINE T-8990 and ASTROSHINE T-8765 (both manufactured by Nihonboshitsu Co., Ltd.).

In the present invention, the metal powder is preferably dispersed in the polymerizable compound. That is, the metal powder is preferably dispersed not in water or a solvent but in the polymerizable compound. The metal powder preferably has a volume-average particle size of 5 to 30 μm in the ink composition, more preferably 5 to 20 μm, and yet more preferably 6 to 16 μm.

In the present invention, the volume-average particle size may be measured using a laser diffraction/scattering particle size distribution analyzer (product name: Microtrac MT3300EX, manufactured by Nikkiso Co., Ltd.), etc. by diluting with the same liquid as a dispersion medium.

In the present invention, the content of the metal powder is preferably 1 to 30 wt % relative to the total amount (total weight) of the ink composition, more preferably 3 to 20 wt %, and yet more preferably 5 to 18 wt %.

It is preferable for the content of the metal powder to be 1 wt % or greater since a good sensation of brightness can be obtained. Furthermore, it is preferable for the content of the metal powder to be no greater than 30 wt % since the stability of the ink composition is good.

The inkjet ink composition of the present invention is preferably a dispersion comprising the polymerizable compound, the photopolymerization initiator, and the metal powder dispersed in a non-aqueous system.

The inkjet ink composition of the present invention may be prepared (made into an ink) by, for example, adding the polymerizable compound, the photopolymerization initiator, the metal powder, and as necessary various types of additive. In the present invention, it is preferable to use a dispersant when preparing the ink composition, and it is more preferable to use an acidic dispersant as the dispersant. It is also possible to prepare the inkjet ink composition of the present invention by first preparing a dispersion having a high metal powder concentration, and diluting this by adding the polymerizable compound, various types of additive, etc.

For dispersion of the metal powder (metal powder pigment), for example, dispersion equipment such as a ball mill, a sand mill, an attritor, a roll mill, a jet mill, a homogenizer, a paint shaker, a kneader, an agitator, a Henschel mixer, a colloid mill, an ultrasonic homogenizer, a pearl mill, or a wet type jet mill may be used.

In the present invention, when carrying out dispersion, it is preferable to finely disperse at least the metal powder, the polymerizable compound, and the dispersant using beads (dispersion media). As dispersion equipment, a ball mill, an agitator mill, a paint shaker, etc. may be used.

Examples of the beads (dispersion media) include glass beads, stainless steel beads, alumina beads, zirconia beads and zircon beads; among them it is preferable to use zirconia beads and zircon beads as the beads (dispersion media). The zirconia beads and zircon beads are preferable since they have excellent strength and hardness and there is little powder generated as a result of cutting of the beads (dispersion media).

When dispersion of the metal powder is carried out as described above, it is preferable to add a dispersant.

In the present invention, it is preferable to use an acidic dispersant as the dispersant, and the acidic dispersant referred to here means a polymer compound having an acidic pigment-affinic group at one terminus of the main chain by means of a block or graft structure. It is preferable to use an acidic dispersant since dispersion of the metal powder proceeds quickly and a stable dispersion can be obtained.

Examples of the acidic pigment-affinic group include a carboxyl group, a sulfonic acid group, and a phosphoric acid group.

Examples of the polymer include polyacrylate, polyurethane, polyester, and modified products thereof.

These dispersants are commercially available, and examples thereof include DISPERBYK-102, DISPERBYK-110, DISPERBYK-111, DISPERBYK-112, and DISPERBYK-180 (all manufactured by BYK-Chemie) and Solsperse 26000, Solsperse 36000, and Solsperse 41000 (all manufactured by Avecia).

The dispersant may be used singly or in a combination of two or more types.

In the ink composition, a solvent may be added as a dispersion medium for various components such as the metal powder; alternatively the polymerizable compound, which is a low molecular weight component, may be used as a dispersion medium without using a solvent, and it is preferable, since the inkjet ink composition of the present invention is a radiation-curing ink and is cured after the ink is applied to a recording material, for the ink to be solventless or to be a low solvent ink. This is because if solvent remains in the cured ink image the solvent resistance is degraded or a VOC (Volatile Organic Compound) problem occurs due to the remaining solvent.

When the inkjet ink composition of the present invention has a solventless or low solvent constitution, a problem such as nozzle clogging due to an increase in viscosity caused by evaporation of water or solvent does not occur, unlike the case with an aqueous ink or a solvent ink, and the discharge properties, etc. of the ink can be improved.

### Colorant

In addition to the metal powder (metal powder pigment), it is possible to add to the inkjet ink composition of the present invention an auxiliary colorant as necessary. The colorant that can be used in the inkjet ink composition of the present invention is not particularly limited, and various known coloring materials (pigments and dyes other than the metal powder pigment) may be selected appropriately and used according to the intended purpose as long as the effects of the present invention are not impaired. For example, when forming an image having excellent weather resistance, a pigment is preferable.

### Pigment

The pigment that can be used together with the metal powder in the present invention is now explained.

The pigment other than the metal powder (metal powder pigment) is not particularly limited, and it is possible to use any generally commercially available organic pigment or inorganic pigment, a dispersion of a pigment in an insoluble resin, etc. as a dispersion medium, a pigment on the surface of which a resin has been grafted, etc. It is also possible to use resin particles colored with a dye, etc.

Examples of these pigments include pigments described in ‘Ganryo no Jiten’ (Dictionary of Pigments) Ed. by Seijirou Ito (2000), W. Herbst, K. Hunger ‘Industrial Organic Pigments’, JP-A-2002-12607, JP-A-2002-188025, JP-A-2003-26978, and JP-A-2003-342503.

Specific examples of the organic pigment and the inorganic pigment that can be used in the present invention include, as those exhibiting a yellow color, monoazo pigments such as CI Pigment Yellow 1 (Fast Yellow G, etc.) and CI Pigment Yellow 74, disazo pigments such as CI Pigment Yellow 12 (Disazo Yellow AAA, etc.) and CI Pigment Yellow 17, benzidine-free azo pigments such as Cl Pigment Yellow 180, azo lake pigments such as CI Pigment Yellow 100 (Tartrazine Yellow Lake, etc.), condensed azo pigments such as CI Pigment Yellow 128, Cl Pigment Yellow 93, and CI Pigment Yellow 95 (Azo Condensation Yellow GR, etc.), acidic dye lake pigments such as CI Pigment Yellow 115 (Quinoline Yellow Lake, etc.), basic dye lake pigments such as CI Pigment Yellow 18 (Thioflavine Lake, etc.), anthraquinone pigments such as Flavanthrone Yellow (Y-24), isoindolinone pigments such as Isoindolinone Yellow 3RLT (Y-110), quinophthalone pigments such as Quinophthalone Yellow (Y-138), isoindoline pigments such as Isoindoline Yellow (Y-139), nitroso pigments such as CI Pigment Yellow 153 (Nickel Nitroso Yellow, etc.), and metal complex azomethine pigments such as CI Pigment Yellow 117 (Copper Azomethine Yellow, etc.).

Examples of pigments exhibiting a red or magenta color include monoazo pigments such as CI Pigment Red 3 (Toluidine Red, etc.), disazo pigments such as CI Pigment Red 38 (Pyrazolone Red B, etc.), azo lake pigments such as Cl Pigment Red 53:1 (Lake Red C, etc.) and CI Pigment Red 57:1 (Brilliant Carmine 6B), condensed azo pigments such as CI Pigment Red 144 (Azo Condensation Red BR, etc.), acidic dye lake pigments such as CI Pigment Red 174 (Phloxine B Lake, etc.), basic dye lake pigments such as CI Pigment Red 81 (Rhodamine 6G′ Lake, etc.), anthraquinone pigments such as CI Pigment Red 177 (Dianthraquinonyl Red, etc.), thioindigo pigments such as CI Pigment Red 88 (Thioindigo Bordeaux, etc.), perinone pigments such as CI Pigment Red 194 (Perinone Red, etc.), perylene pigments such as CI Pigment Red 149 (Perylene Scarlet, etc.), quinacridone pigments such as CI Pigment violet 19 (unsubstituted quinachridone) and CI Pigment Red 122 (Quinacridone Magenta, etc.), isoindolinone pigments such as CI Pigment Red 180 (Isoindolinone Red 2BLT, etc.), and alizarin lake pigments such as CI Pigment Red 83 (Madder Lake, etc.).

Examples of pigments exhibiting a blue or cyan color include disazo pigments such as CI Pigment Blue 25 (Dianisidine Blue, etc.), phthalocyanine pigments such as CI Pigment Blue 15 (Phthalocyanine Blue, etc.), acidic dye lake pigments such as CI Pigment Blue 24 (Peacock Blue Lake, etc.), basic dye lake pigments such as CI Pigment Blue 1 (Victoria Pure Blue BO Lake, etc.), anthraquinone pigments such as CI Pigment Blue 60 (Indanthrone Blue, etc.), and alkali blue pigments such as CI Pigment Blue 18 (Alkali Blue V-5:1).

Examples of pigments exhibiting a green color include phthalocyanine pigments such as CI Pigment Green 7 (Phthalocyanine Green) and CI Pigment Green 36 (Phthalocyanine Green), and azo metal complex pigments such as Cl Pigment Green 8 (Nitroso Green).

Examples of pigments exhibiting an orange color include isoindoline pigments such as CI Pigment Orange 66 (Isoindoline Orange) and anthraquinone pigments such as CI Pigment Orange 51 (Dichloropyranthrone Orange).

Examples of pigments exhibiting a black color include carbon black, titanium black, and aniline black.

Dispersion of the pigment may be carried out in the same manner as for dispersion of the metal powder in the present invention.

The colorant is used in a range that does not impair the effects of the present invention, and is preferably added at 0.05 to 20 wt % relative to the total amount (total weight) of the ink composition, and more preferably 0.2 to 10 wt %.

### Surfactant

It is preferable for the inkjet ink composition of the present invention to comprise a surfactant.

Examples of the surfactant include those described in JP-A-62-173463 and 62-183457. Specific examples thereof include anionic surfactants such as dialkylsulfosuccinic acid salts, alkylnaphthalenesulfonic acid salts, and fatty acid salts, nonionic surfactants such as polyoxyethylene alkyl ethers, polyoxyethylene alkyl allyl ethers, acetylene glycols, and polyoxyethylene/polyoxypropylene block copolymers, and cationic surfactants such as alkylamine salts and quaternary ammonium salts. An organofluoro compound may be used instead of the above-mentioned known surfactant. The organofluoro compound is preferably hydrophobic. Examples of the organofluoro compound include fluorine-based surfactants, oil-like fluorine-based compounds (e.g. fluorine oil), solid fluorine compound resins (e.g. tetrafluoroethylene resin), and those described in JP-B-57-9053 (paragraphs 8 to 17) and JP-A-62-135826.

The content of the surfactant in the present invention is preferably 0.001 to 0.6 wt % relative to the polymerizable compound, more preferably 0.003 to 0.3 wt %, and particularly preferably 0.01 to 0.1 wt %.

### Additive

The inkjet ink composition of the present invention may comprise, in addition to the essential components, various types of additive according to the intended purpose. These optional components are now explained.

### Sensitizing Dye

In the present invention, in order to improve the sensitivity of the photopolymerization initiator, a sensitizing dye may be added. The sensitizing dye is explained below.

Preferred examples of the sensitizing dye include those in the categories of compounds below and have an adsorption wavelength in the region of 350 nm to 450 nm.

Examples thereof include polynuclear aromatic compounds (e.g. pyrene, perylene, triphenylene, 2-ethyl-9,10-dimethoxyanthracene), xanthenes (e.g. fluorescein, eosin, erythrosine, rhodamine B, rose bengal), cyanines (e.g. thiacarbocyanine, oxacarbocyanine), merocyanines (e.g. merocyanine, carbomerocyanine), thiazines (e.g. thionine, methylene blue, toluidine blue), acridines (e.g. acridine orange, chloroflavine, acriflavine), anthraquinones (e.g. anthraquinone), squaryliums (e.g. squarylium), and coumarins (e.g. 7-diethylamino-4-methylcoumarin).

Preferred examples of the sensitizing dye that can be used in the present invention include compounds represented by Formulae (vi) to (x) below.

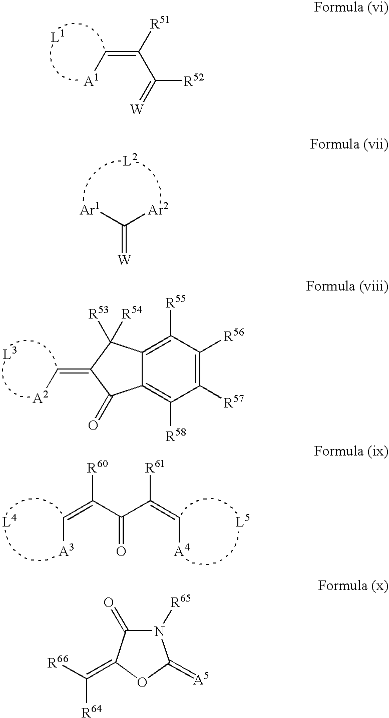

In Formula (vi), A¹ denotes a sulfur atom or NR⁵⁰, and R⁵⁰ denotes a substituted or unsubstituted alkyl group or an aryl group. L¹ denotes a non-metallic atomic group forming a basic nucleus of a dye in cooperation with the adjacent A¹ and adjacent carbon atom. R⁵¹ and R⁵² independently denote a hydrogen atom or a monovalent non-metallic atomic group, and R⁵¹ and R⁵² may be bonded together to form an acidic nucleus of a dye. W denotes an oxygen atom or a sulfur atom.

In Formula (vii), Ar¹ and Ar² independently denote an aryl group and are connected to each other via bonding with L². Here, L² denotes —O— or —S—. W has the same meaning as that shown in Formula (vi).

In Formula (viii), A² denotes a sulfur atom or NR⁵⁹, and R⁵⁹ denotes a substituted or unsubstituted alkyl group or an aryl group. L³ denotes a non-metallic atomic group forming a basic nucleus of a dye in cooperation with the adjacent A and carbon atom. R⁵³ R⁵⁴ R⁵⁵ R⁵⁶ R⁵⁷ and R⁵⁸ independently denote a monovalent non-metallic atomic group.

In Formula (ix), A³ and A⁴ independently denote —S—, —NR⁶²—, or —NR⁶³—, and R⁵² and R⁶³ independently denote a substituted or unsubstituted alkyl group or a substituted or unsubstituted aryl group. L⁴ and L⁵ independently denote a non-metallic atomic group forming a basic nucleus of a dye in cooperation with the adjacent A³, A⁴, and adjacent carbon atom. R⁶⁰ and R⁶¹ independently denote a hydrogen atom or a monovalent non-metallic atomic group. R⁶⁰ and R⁶¹ may be bonded to each other to form an aliphatic or aromatic ring.

In Formula (x), R⁶⁶ denotes an aromatic ring or a hetero ring, which may have a substituent. A⁵ denotes an oxygen atom, a sulfur atom, or —NR⁶⁷—. R⁶⁴, R⁶⁵, and R⁶⁷ independently denote a hydrogen atom or a monovalent non-metallic atomic group. R⁶⁷ and R⁶⁴, and R⁶⁵ and R⁶⁷ may be bonded to each other to form an aliphatic or aromatic ring.

Preferred examples of the compounds represented by Formulae (vi) to (x) include (C-1) to (C-26) below, but are not limited thereto.

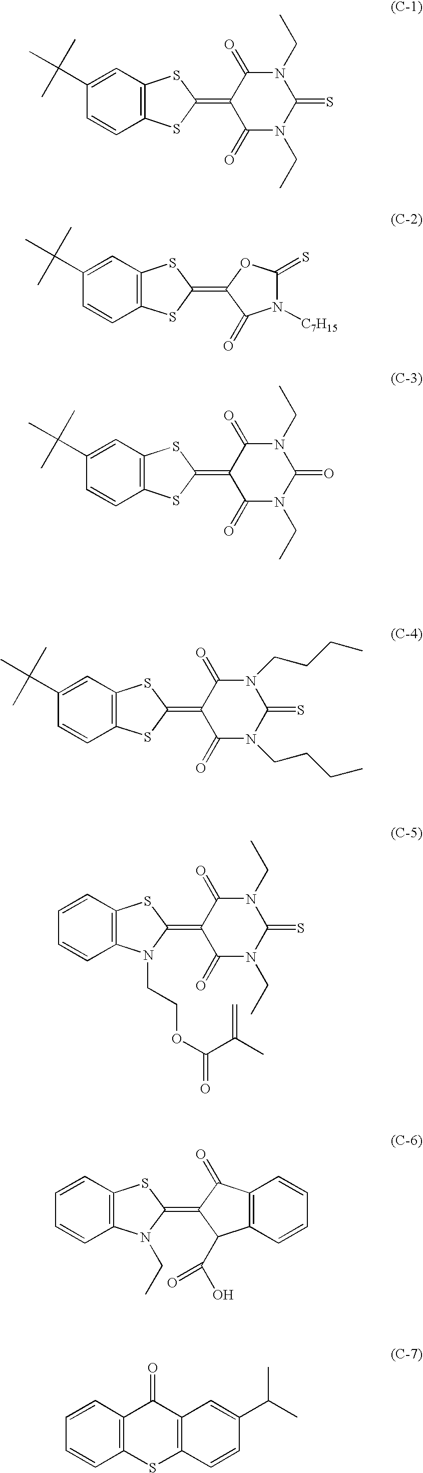

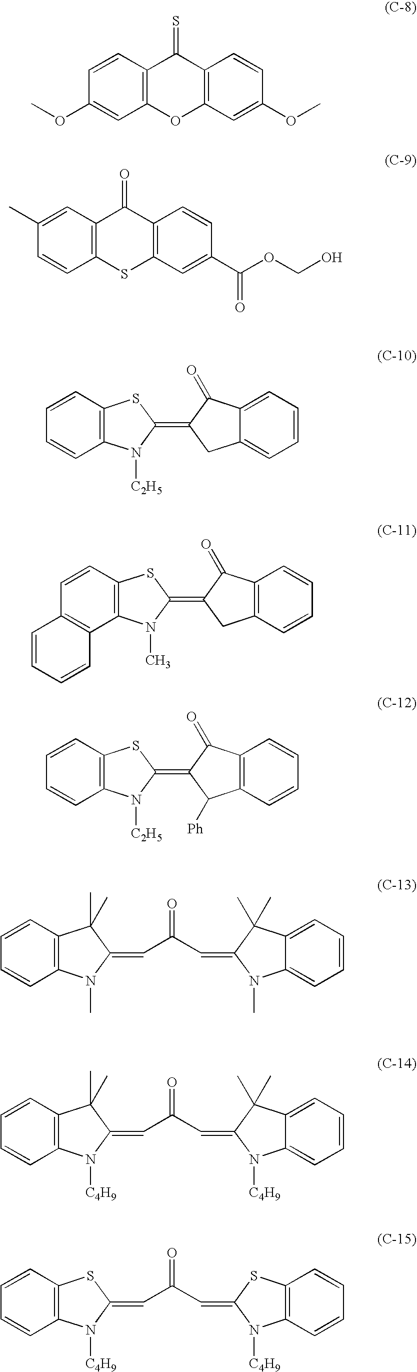

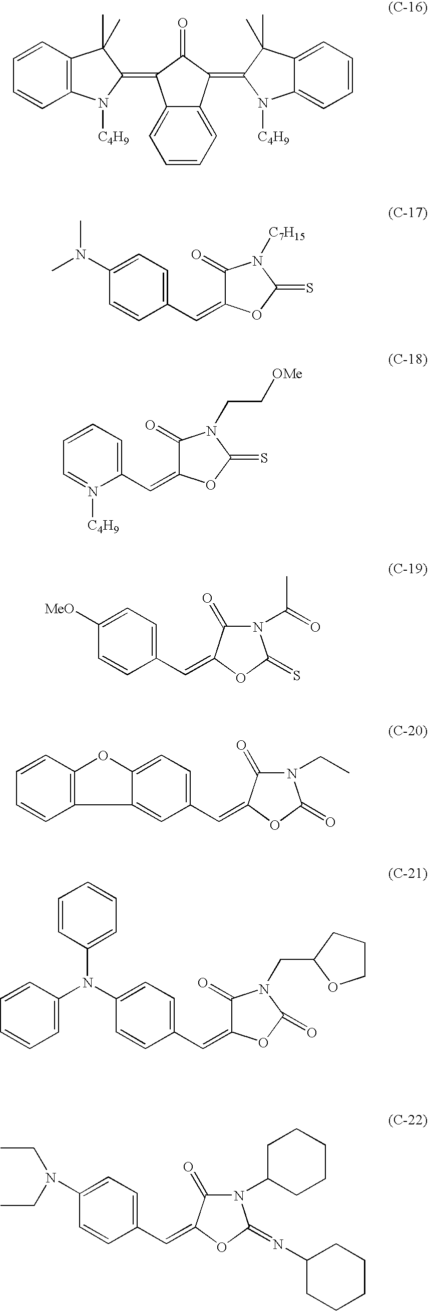

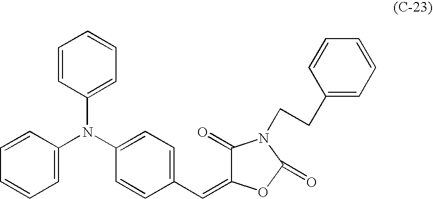

From the viewpoint of the coloring properties of the ink, the content of the sensitizing dye in the ink composition of the present invention is preferably 0.01 to 20 wt % relative to the entire solids content of the ink composition, more preferably 0.1 to 15 wt %, and yet more preferably 0.5 to 10 wt %.

The sensitizing dye may be used singly or in a combination of two or more types.

Furthermore, from the viewpoint of improvement of decomposition efficiency of the photopolymerization initiator and transparency to irradiating light, the ratio of the photopolymerization initiator to the sensitizing dye contained in the ink composition is preferably (photopolymerization initiator/sensitizing dye)=100 to 0.05 as a ratio by weight, more preferably (photopolymerization initiator/sensitizing dye)=50 to 0.1, and yet more preferably (photopolymerization initiator/sensitizing dye)=10 to 0.5.

### Cosensitizer

The inkjet ink composition of the present invention preferably comprises a cosensitizer which has the function of further improving the sensitivity of the sensitizing dye to actinic radiation or the function of suppressing inhibition by oxygen of polymerization of a polymerizable compound, etc.

Examples of such a cosensitizer include amines such as compounds described in M. R. Sander et al., ‘Journal of Polymer Society’, Vol. 10, p. 3173 (1972), JP-B-44-20189, JP-A-51 -82102, JP-A-52-134692, JP-A-59-138205, JP-A-60-84305, JP-A-62-18537, JP-A-64-33104, and Research Disclosure No. 33825, and specific examples thereof include triethanolamine, ethyl p-dimethylaminobenzoate, p-formyldimethylaniline, and p-methylthiodimethylaniline.

Other examples of the cosensitizer include thiols and sulfides such as thiol compounds described in JP-A-53-702, JP-B-55-500806, and JP-A-5-142772, and disulfide compounds of JP-A-56-75643, and specific examples thereof include 2-mercaptobenzothiazole, 2-mercaptobenzoxazole, 2-mercaptobenzimidazole, 2-mercapto-4(3H)-quinazoline, and β-mercaptonaphthalene.

Yet other examples of the cosensitizer include amino acid compounds (e.g. N-phenylglycine, etc.), organometallic compounds described in JP-B-48-42965 (e.g. tributyltin acetate, etc.), hydrogen-donating compounds described in JP-B-55-34414, sulfur compounds described in JP-A-6-308727 (e.g. trithiane, etc.), phosphorus compounds described in JP-A-6-250387 (diethylphosphite, etc.), and Si—H or Ge—H compounds described in JP-A-8-54735.

The amount thereof added is appropriately selected according to the intended application, and it is preferably on the order of 0.01 to 10 wt % relative to the total amount (total weight) of the ink composition.

### Polymerization Inhibitor

The inkjet ink composition of the present invention may comprise at least one type of polymerization inhibitor.

Preferred examples of the polymerization inhibitor include compounds selected from the group consisting of a phenol-based hydroxyl group-containing compound, a quinone, an N-oxide compound, a piperidin-1-oxyl free radical compound, a pyrrolidin-1-oxyl free radical compound, an N-nitrosophenylhydroxylamine, and a cationic dye.

Specific examples include hydroquinone, p-methoxyphenol, di-t-butyl-p-cresol, pyrogallol, resorcinol, catechol, t-butylcatechol, hydroquinone monoalkyl ethers (e.g. hydroquinone monomethyl ether, hydroquinone monobutyl ether, etc.), benzoquinone, 4,4′-thiobis(3-methyl-6-t-butylphenol), 2,2′-methylenebis(4-methyl-6-t-butylphenol), 2,2,6,6-tetramethylpiperidine and derivatives thereof, di-t-butyl nitroxide, 2,2,6,6-tetramethylpiperidine N-oxide and derivatives thereof, piperidin-1-oxyl free radical, 2,2,6,6-tetramethylpiperidin-1-oxyl free radical, 4-oxo-2,2,6,6-tetramethylpiperidin-1-oxyl free radical, 4-hydroxy-2,2,6,6-tetramethylpiperidin-1-oxyl free radical, 4-acetamido-2,2,6,6-tetramethylpiperidin-1-oxyl free radical, 4-maleimido-2,2,6,6-tetramethylpiperidin-1-oxyl free radical, 4-phosphonoxy-2,2,6,6-tetramethylpiperidin-1-oxyl free radical, 3-carboxy-2,2,5,5-tetramethylpyrrolidin-1-oxyl free radical, N-nitrosophenylhydroxylamine cerous salt, N-nitrosophenylhydroxylamine aluminum salt, crystal violet, methyl violet, ethyl violet, and Victoria Pure Blue BOH.

Among them, hydroquinone monoalkyl ethers such as hydroquinone monomethyl ether and hydroquinone monobutyl ether and hindered phenols such as 4,4′-thiobis(3-methyl-6-t-butylphenol) and 2,2′-methylenebis(4-methyl-6-t-butylphenol) are preferable.

The content of the polymerization inhibitor in the ink composition is preferably 50 to 30,000 ppm relative to the total amount (total weight) of the ink composition, more preferably 100 to 10,000 ppm, and yet more preferably 100 to 3,000 ppm.

It is preferable for the content of the polymerization inhibitor to be 50 ppm or greater since the stability of the ink composition improves. It is also preferable for it to be no greater than 30,000 ppm since this does not block curing of the ink composition when exposed to actinic radiation.

### UV Absorber

A UV absorber may be used from the viewpoint of improving the weather resistance of an image obtained and preventing discoloration.

The UV absorbers include benzotriazole compounds described in JP-A-58-185677, JP-A-61-190537, JP-A-2-782, JP-A-5-197075 and JP-A-9-34057; benzophenone compounds described in JP-A-46-2784, JP-A-5-194483 and U.S. Pat. No. 3,214,463; cinnamic acid compounds described in JP-B-48-30492, JP-B-56-21141 and JP-A-10-88106; triazine compounds described in JP-A-4-298503, JP-A-8-53427, JP-A-8-239368, JP-A-10-182621 and JP-W-8-501291 (the term “JP-W” as used herein means an unexamined published international patent application); compounds described in Research Disclosure No.24239; and compounds represented by stilbene and benzoxazole compounds, which absorb ultraviolet rays to emit fluorescence, the so-called fluorescent brightening agents.

The amount thereof added is appropriately selected according to the intended application, and it is preferably on the order of 0.01 to 10 wt % relative to the total amount (total weight) of the ink composition.

### Antioxidant

In order to improve the stability of the inkjet ink composition, an antioxidant may be added. Examples of the antioxidant include those described in Laid-open European Patent Nos. 223739, 309401, 309402, 310551, 310552, and 459416, Laid-open German Patent No. 3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449, and US Pat. Nos. 4,814,262 and 4,980,275.

The amount thereof added is appropriately selected according to the intended application, and it is preferably on the order of 0.1 to 8 wt % relative to the total amount (total weight) of the ink composition.

### Antifading Agent

The inkjet ink composition of the present invention may employ various organic and metal complex antifading agents. The organic antifading agents include hydroquinones, alkoxyphenols, dialkoxyphenols, phenols, anilines, amines, indanes, chromans, alkoxyanilines, and heterocycles, and the metal complex antifading agents include nickel complexes and zinc complexes. More specifically, there can be used compounds described in patents cited in Research Disclosure, No. 17643, Items VII-I to J, ibid., No.15162, ibid., No.18716, page 650, left-hand column, ibid., No. 36544, page 527, ibid., No. 307105, page 872, and ibid., No. 15162, and compounds contained in general formulae and compound examples of typical compounds described in JP-A-62-21572, pages 127 to 137.

The amount thereof added is appropriately selected according to the intended application, and it is preferably on the order of 0.01 to 10 wt % relative to the total amount (total weight) of the ink composition.

### Conductive Salt

The inkjet ink composition of the present invention may contain, for the purpose of controlling discharge properties, a conductive salt such as potassium thiocyanate, lithium nitrate, ammonium thiocyanate, or dimethylamine hydrochloride.

### Solvent

It is also effective to add a trace amount of organic solvent to the inkjet ink composition of the present invention in order to improve the adhesion to a recording medium.

Examples of the solvent include ketone-based solvents such as acetone, methyl ethyl ketone, and diethyl ketone, alcohol-based solvents such as methanol, ethanol, 2-propanol, 1-propanol, 1-butanol, and tert-butanol, chlorine-based solvents such as chloroform and methylene chloride, aromatic-based solvents such as benzene and toluene, ester-based solvents such as ethyl acetate, butyl acetate, and isopropyl acetate, ether-based solvents such as diethyl ether, tetrahydrofuran, and dioxane, and glycol ether-based solvents such as ethylene glycol monomethyl ether and ethylene glycol dimethyl ether.

In this case, it is effective if the amount thereof added is in a range that does not cause problems with the solvent resistance or the VOC, and the amount is preferably in the range of 0.1 to 5 wt % relative to the total amount of the ink composition, and more preferably 0.1 to 3 wt %.

### High Molecular Weight Compound

The inkjet ink composition may contain various types of high molecular weight compounds in order to adjust film physical properties. Examples of the high molecular weight compounds include acrylic polymers, polyvinylbutyral resins, polyurethane resins, polyamide resins, polyester resins, epoxy resins, phenol resins, polycarbonate resins, polyvinylbutyral resins, polyvinylformal resins, shellac, vinylic resins, acrylic resins, rubber-based resins, waxes, and other natural resins. They may be used in a combination of two or more types. Among these, a vinylic copolymer obtained by copolymerization of an acrylic monomer is preferable. Furthermore, as a copolymer component of the high molecular weight compound, a copolymer containing as a structural unit a ‘carboxyl group-containing monomer’, an ‘alkyl methacrylate ester’, or an ‘alkyl acrylate ester’ may preferably be used.

In addition to the above, the composition may contain as necessary, for example, a leveling additive, a matting agent, a wax for adjusting film physical properties, or a tackifier in order to improve the adhesion to a recording medium such as polyolefin or PET, the tackifier not inhibiting polymerization.

Specific examples of the tackifier include high molecular weight tacky polymers described on pp. 5 and 6 of JP-A-2001-49200 (e.g. a copolymer formed from an ester of (meth)acrylic acid and an alcohol having an alkyl group with 1 to 20 carbons, an ester of (meth)acrylic acid and an alicyclic alcohol having 3 to 14 carbons, or an ester of (meth)acrylic acid and an aromatic alcohol having 6 to 14 carbons), and a low molecular weight tackifying resin having a polymerizable unsaturated bond.

### Preferred Physical Properties of Ink Composition

As the inkjet ink composition of the present invention is applied to inkjet recording, taking into consideration the discharge characteristics, the ink viscosity at the discharge temperature is preferably 5 to 30 mPa·s, and more preferably 7 to 20 mPa·s. The component ratio is therefore adjusted as appropriate so that the viscosity is in the above-mentioned range.

The viscosity of the ink composition at room temperature (25° C.) is preferably 7 to 120 mPa·s, and more preferably 10 to 80 mPa·s. It is preferable to set the viscosity at room temperature in the above-mentioned range since, even when a porous recording material is used, it is possible to prevent the ink from penetrating into the recording material, reduce uncured monomer, suppress odor, and prevent dot spreading when an ink droplet lands, and as a result image quality can be improved.

The surface tension of the inkjet ink composition of the present invention is preferably 20 to 40 mN/m, and more preferably 20 to 30 mN/m. When the inkjet ink composition of the present invention is used for recording on various recording materials such as polyolefin, PET, coated paper, and non-coated paper, from the viewpoint of spreading and permeation, the surface tension is preferably at least 20 mN/m, and from the viewpoint of wettability it is preferably no greater than 40 mN/m.

The inkjet ink composition of the present invention can be used suitably as an ink for inkjet recording. The inkjet recording method is not particularly limited, and examples thereof include a charge control method in which an ink is discharged by utilizing electrostatic attraction, a drop-on-demand method (pressure pulse method) in which oscillatory pressure of a piezo element is utilized, an acoustic inkjet method in which an electric signal is changed into an acoustic beam and applied to an ink, and the ink is discharged utilizing radiation pressure, and a thermal inkjet method in which an ink is heated so as to form an gas bubble, and the pressure thus generated is utilized. The inkjet recording method also includes a method in which an ink called a photo ink, which has a low concentration, is discharged a large number of times in small volume, a method in which image quality is improved using a plurality of inks having substantially the same hue but different concentrations, and a method in which a colorless transparent ink is used.

Among them, it is suitable as an ink for inkjet recording by the drop on-demand method (pressure pulse method) employing a piezo element.

### Image Formation Method and Recorded Material

The image formation method of the present invention comprises a step of recording an image by inkjet recording on a recording material using the above-mentioned inkjet ink composition of the present invention (image recording step) and a step of curing the recorded image by irradiation with actinic radiation (actinic rays) (image curing step). In the present invention, by using actinic radiation in the image curing step and irradiating the image recorded on the recording material in the image recording step with actinic radiation, polymerization and curing of the polymerizable compound, which contributes to the formation of the image, proceed, and a well cured highly robust image can thus be formed.

In the present invention, the image is optical information such as characters, figures, tables, or photographs, and may be any of black and white, monochrome, and full color.

In the inkjet recording method, an image is recorded on a recording material using the inkjet ink composition of the present invention; an ink discharge nozzle, etc. used here is not particularly limited and may be selected as appropriate according to the intended purpose. The inkjet recording method is not particularly limited, and details are as described above.

In the image curing step, exposure for promoting polymerization and curing may be carried out using a light source emitting actinic radiation having a wavelength region corresponding to the sensitive wavelength of the ink composition. Specifically, a light source emitting actinic rays in a wavelength region of 240 to 450 nm such as, for example, an LD, an LED, a fluorescent lamp, a low pressure mercury lamp, a high pressure mercury lamp, a metal halide lamp, a carbon arc lamp, a xenon lamp, or a chemical lamp may be suitably used. Preferred examples of the light source include an LED, a high pressure mercury lamp, and a metal halide lamp. The exposure time and the light intensity may be selected as appropriate according to the degree of polymerization and curing of the polymerizable compound related to the present invention.

### Recording Material

As a recording material used in the present invention, both an ink-permeable recording material and an ink-impermeable recording material may be used. Examples of the ink-permeable recording material include plain paper, inkjet paper, coated paper, electrophotographic multi-purpose paper, fabric, nonwoven fabric, porous membranes, and polymer absorbers. They are described as‘recording materials’ in JP-A-2001-1891549, etc.

In order for the effects of the present invention to be exhibited, it is preferable to use an ink-impermeable recording material. Examples of the ink-impermeable recording material include art paper, synthetic resin, rubber, resin-coated paper, glass, metal, ceramic, and wooden materials. In addition, in order to impart various functions, a composite substrate in which a plurality of these materials are combined may be used.

As the synthetic resin, any synthetic resin may be used, and examples thereof include polyesters such as polyethylene terephthalate and polybutadiene terephthalate; polyolefins such as polyvinyl chloride, polystyrene, polyethylene, polyurethane, and polypropylene; acrylic resin, polycarbonate, acrylonitrile-butadiene-styrene copolymer, diacetate, triacetate, polyimide, cellophane, and celluloid.

The shape (thickness) of a substrate employing the synthetic resin may be a film shape, a card shape, or a block shape, but is not particularly limited, and may be selected as appropriate according to the intended purpose. These synthetic resins may be transparent or opaque. One preferred application form of the synthetic resin is a film used for so-called flexible packaging, and various types of non-absorbing plastics and films thereof may be used. Examples of films made of various types of plastic include PET film, OPS film, OPP film, ONy film, PVC film, PE film, and TAC film.

Examples of the resin-coated paper include transparent polyester film, opaque polyester film, opaque polyolefin resin film, and a paper support having both sides laminated with a polyolefin resin, and the paper support having both sides laminated with a polyolefin resin is particularly preferable.

As hereinbefore described, in accordance with image recording using the inkjet ink composition of the present invention, a high quality and high strength robust image can be obtained, and the recorded material thus obtained, that is, the recorded material of the present invention, has excellent image robustness and brightness.

In accordance with the present invention, it is possible to provide an inkjet ink composition that enables an image to be formed on various types of recording material with high image robustness and excellent surface gloss, an image formation method that enables a robust, high quality image to be formed stably using the inkjet ink composition, and a recorded material employing the inkjet ink composition.

### EXAMPLES

The present invention is explained in further detail by reference to Examples, but the present invention should not be construed as being limited thereto.

### Example 1

### Preparation of Metal Powder Dispersion

A metal powder paste, a dispersant, and a polymerizable compound shown in Table 1 and Table 2 below were dispersed by means of a ball mill using zircon beads having a diameter of 0.6 mm for 16 hours, thus giving a metal powder dispersion. The amounts of the components added in Table 1 and Table 2 are expressed as ‘parts by weight’.

In this process, the volume-average particle size of the metal powder dispersion was measured by a laser diffraction/scattering particle size distribution analyzer (product name: Microtrac MT3300EX, manufactured by Nikkiso Co., Ltd.). The results are given in Table 1 and Table 2 below.

### Preparation of Metal Powder-Containing Ink

A polymerization initiator shown in Table 1 and Table 2 below was added to and dissolved in the metal powder dispersion obtained above. The amount of polymerization initiator added is expressed as ‘wt %’ relative to the polymerizable compound. Subsequently, this liquid was filtered using a 0.8 μm membrane filter, thus giving a metal powder-containing ink composition. The viscosity (mPa·s) at 25° C. of the ink composition thus obtained was measured using an RE type viscometer (manufactured by Toki Sangyo Co., Ltd.). The results are given in Table 1 and Table 2.

In Table 1 radically polymerizable compounds were used as the polymerizable compound, and in Table 2 cationically polymerizable compounds were used.

TABLE 1

| | Metal powder- | Metal powder- | Metal powder- | Metal powder- |
|---|---|---|---|---|
| | containing ink-1 | containing ink-2 | containing ink-3 | containing ink-4 |
| Aluminum flake pigment paste: Eckart | | | | |
| ROTOVARIO 500 022 | 9 (pigment 5.4) | 9 (pigment 5.4) | | |
| ROTOVARIO 500 020 | | | 9 (pigment 5.4) | 9 (pigment 5.4) |
| Polymerizable compound | | | | |
| HDDA: Daicel-UCB Co., Ltd. | 76 | 50 | 75 | 50 |
| DPCA60: Sartomer | 25 | | 25 | |
| SR-494: Sartomer | | 50 | | 50 |
| Dispersant | | | | |
| Solsperse 36000: Lubrizol | 1.8 | | 1.8 | |
| Solsperse 41000: Lubrizol | | 1.8 | | 1.8 |
| Polymerization initiator | | | | |
| Irgacure 1870 | 6% | 6% | 6% | 6% |
| Volume-average particle size (μm) | 10.5 | 10.3 | 15.1 | 14.6 |
| Viscosity (mPa · s) | 23.3 | 24.8 | 22 | 23.5 |

TABLE 2

| | Metal powder- | Metal powder- | Metal powder- | Metal powder- |
|---|---|---|---|---|
| | containing ink-5 | containing ink-6 | containing ink-7 | containing ink-8 |
| Aluminum flake pigment paste: | | | | |
| Nihonboshitsu Co., Ltd. | | | | |
| ASTROSHINE T-8990 | 8 (pigment 5.6) | 8 (pigment 5.6) | | |
| ASTROSHINE T-8765 | | | 8 (pigment 5.6) | 8 (pigment 5.6) |
| Polymerizable compound | | | | |
| OXT-221: Toagosei Co., Ltd. | 85 | 85 | 85 | 85 |
| Celloxide 2021A: Daicel-UCB Co., Ltd. | 15 | 15 | 15 | 15 |
| Dispersant | | | | |
| DISPERBYK-112: BYK-Chemie | 3 | | 3 | 2 |
| DISPERBYK-180: BYK-Chemie | | 2 | | |
| Polymerization initiator | | | | |
| CPI-100P: San-Apro Ltd. | 6% | 6% | 6% | 6% |
| Volume-average particle size (μm) | 7 | 6.8 | 13.3 | 13.2 |
| Viscosity (mPa · s) | 21.9 | 22.5 | 20.3 | 20.1 |

### In Table 1 and Table 2

HDDA: 1,6-hexanediol diacrylate, manufactured by Daicel-UCB Co., Ltd. (radically polymerizable monomer)
DPCA60: caprolactone-modified dipentaerythritol hexaacrylate, manufactured by Sartomer (radically polymerizable monomer)
SR-494: ethoxylated pentaerythritol hexaacrylate, manufactured by Sartomer (radically polymerizable monomer)
Solsperse 36000: manufactured by Lubrizol (polymeric dispersant)
Solsperse 41000: manufactured by Lubrizol (polymeric dispersant)
Irgacure 1870: manufactured by Ciba Specialty Chemicals (radical photopolymerization initiator)
DISPERBYK-112: manufactured by BYK-Chemie (polymeric dispersant)
DISPERBYK-180: manufactured by BYK-Chemie (polymeric dispersant)
OXT-221 (Aron oxetane OXT-221): bis{[1-ethyl(3-oxetanyl)]methyl}ether, manufactured by Toagosei Co., Ltd. (cationically polymerizable monomer)
Celloxide 2021 A: (3′,4′-epoxycyclohexane)methyl 3,4-epoxycyclohexanecarboxylate, manufactured by Daicel-UCB Co., Ltd. (cationically polymerizable monomer)
CPI-100P: manufactured by San-Apro Ltd. (cationic photopolymerization initiator)

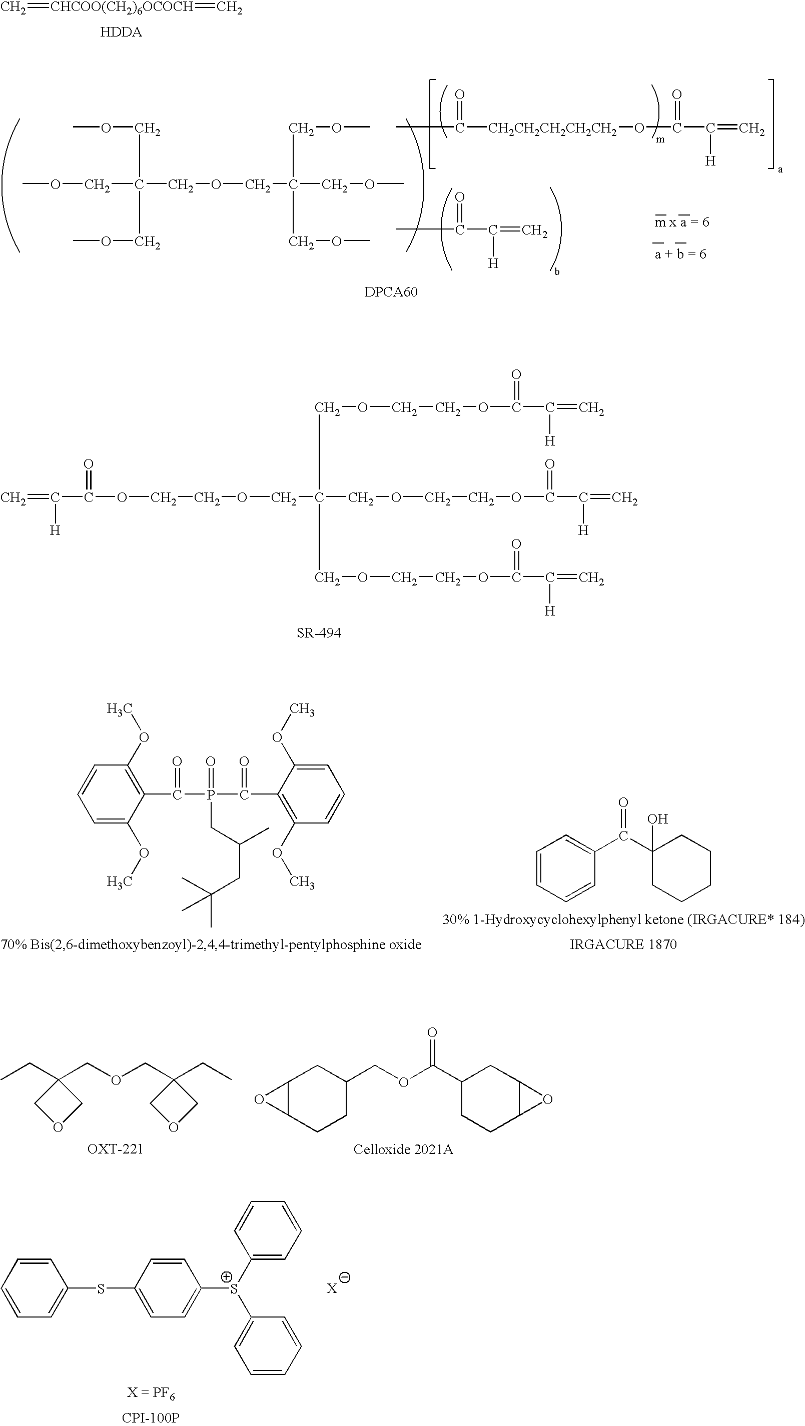

### Comparative Example 1

### Aqueous Ink

### Preparation of Petal Powder Dispersion

A pigment dispersion was obtained by dispersing the composition below by means of a ball mill using glass beads having a diameter of 0.6 mm for 16 hours.

In this process, the volume-average particle size of the metal powder dispersion was measured by a laser diffraction/scattering particle size distribution analyzer (product name: Microtrac MT3300EX, manufactured by Nikkiso Co., Ltd.), and was found to be 11.0 μm.

### Composition

| | | |
|---|---|---|
| Aluminum flake pigment paste: manufactured | 100 | parts by weight |
| by Wolstenholme (Metasheen Slurry 1811, | | |
| aluminum powder pigment 10%) | | |
| Dispersant (Solsperse 20000, manufactured by | 1.2 | parts by weight |
| Avecia) | | |
| Water | 70 | parts by weight |

### Preparation of Ink

The composition below was added to and dissolved in 70 parts by weight of the metal powder dispersion obtained above. Subsequently, the metal powder dispersion was filtered using a 0.8 μm membrane filter, thus giving a metal powder-containing aqueous ink.

### Composition

| | |
|---|---|
| Glycerol | 120 parts by weight |
| Triethylene glycol monobutyl ether | 17 parts by weight |
| Surfynol STG (manufactured by Air | 1 part by weight |
| Products & Chemicals, Inc.) | |

### Image Recording and Evaluation

With regard to the inks containing a metal powder (metal powder pigment) of the present invention and the Comparative Example obtained above, an IJET1000 inkjet tester manufactured by Microjet (nozzle diameter 50 μm×55 μm, printing density 300 dpi, discharge frequency 2 kHz, number of nozzles 64, liquid droplet size about 70 pL) was charged with each ink, and an image was formed by discharging the ink onto the surface of each of (1) an inkjet image receiving paper (‘Kassai’ gloss photo inkjet paper, manufactured by Fuji Photo Film Co., Ltd.), (2) tarpaulin (thickness 130 μm), and (3) PET film (thickness 200 μm). In this process, with regard to the metal powder-containing inks of the Examples, an image sample was obtained by irradiating at an exposure energy of 400 mj/cm² using an ‘SP-7’ Deep UV lamp (manufactured by Ushio Inc.) after printing.

Subsequently, each of the color images thus obtained was evaluated as follows. The evaluation results are given in Table 3 below.

### 1. Brightness

The printed surface was examined visually, and the brightness was evaluated according to the criteria below.

### Criteria

Good: exhibiting a mirror surface-like sensation of brightness.
Fair: weak sensation of brightness.
Poor: hardly any sensation of brightness.

### 2. Abrasion Resistance

After an image surface was rubbed with an eraser several times, the image surface was irradiated with UV light, the degree of sensation of brightness was examined visually, and the abrasion resistance was evaluated according to the criteria below.

### Criteria

Good: exhibiting the same good sensation of brightness as that prior to rubbing with the eraser.
Poor: there were places where the ink had come off, little sensation of brightness exhibited.

### 3. Discharge Properties

Tests was carried out in which the metal powder-containing inks of the present invention and the Comparative Example obtained above were discharged for 10 minutes per day for 7 days, and the occurrence of nozzle clogging was evaluated. The number of days on which nozzle clogging was observed is given in Table 3 below.

TABLE 3

| | | | | | | | | | | Comp. |
|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 |
| Metal-containing ink | | 1 | 2 | 3 | 4 | 5 | 6 | 7 | 8 | Aqueous |
| | | | | | | | | | | ink |
| Brightness | Inkjet image | Fair | Fair | Fair | Fair | Fair | Fair | Fair | Fair | Fair |
| | receiving paper | | | | | | | | | |
| | Tarpaulin | Good | Good | Good | Good | Good | Good | Good | Good | Poor |
| | PET film | Good | Good | Good | Good | Good | Good | Good | Good | Poor |
| Abrasion | Inkjet image | Fair | Fair | Fair | Fair | Fair | Fair | Fair | Fair | Fair |
| resistance | receiving paper | | | | | | | | | |
| | Tarpaulin | Good | Good | Good | Good | Good | Good | Good | Good | Poor |
| | PET film | Good | Good | Good | Good | Good | Good | Good | Good | Poor |

| | | | | | | | | | |
|---|---|---|---|---|---|---|---|---|---|
| Discharge properties | 0 days | 0 days | 0 days | 0 days | 0 days | 0 days | 0 days | 0 days | 6 days |

As shown in Table 3 above, the metal powder-containing inks of the present invention comprising the polymerizable compound and the metal powder in combination had excellent brightness and abrasion resistance, whereas the aqueous ink containing a metal powder in Comparative Example 1 showed poor evaluation results apart from a case in which it was printed on an inkjet image receiving paper.

Furthermore, for the aqueous ink containing a metal powder in Comparative Example 1 there were 6 days when nozzle clogging occurred, but for the metal powder-containing inks of the present invention in the Examples there was no nozzle clogging.

What is claimed is:

1. An inkjet ink composition comprising:
a polymerizable compound;
a photopolymerization initiator; and
a metal powder.

2. The inkjet ink composition according to claim 1, wherein the metal powder is an aluminum powder.

3. The inkjet ink composition according to claim 1, wherein the metal powder is dispersed in the polymerizable compound.

4. The inkjet ink composition according to claim 1, wherein the metal powder has a volume-average particle size of 5 to 30 μm.

5. The inkjet ink composition according to claim 1, wherein the metal powder has a content of 1 to 30 wt % relative to the total weight of the inkjet ink composition.

6. The inkjet ink composition according to claim 1, wherein it comprises an acidic dispersant.

7. The inkjet ink composition according to claim 1, wherein the metal powder is dispersed by means of a bead mill in the presence of the dispersant and the polymerizable compound.

8. The inkjet ink composition according to claim 1, wherein it has a viscosity at 25° C. of 7 to 120 mPa·s.

9. The inkjet ink composition according to claim 1, wherein the polymerizable compound has a content of at least 50 wt % but no greater than 98 wt % relative to the total weight of the inkjet ink composition.

10. The inkjet ink composition according to claim 1, wherein the polymerizable compound comprises at least one type of oxetane group-containing compound and at least one type of oxirane group-containing compound.

11. The inkjet ink composition according to claim 1, wherein the polymerizable compound comprises at least one type selected from the group consisting of a monofunctional (meth)acrylate and a difunctional (meth)acrylate, and at least one type of tri- or higher-functional (meth)acrylate compound.

12. An image formation method comprising:
an image recording step of recording an image on a recording material by inkjet recording in which the inkjet ink composition according to claim 1 is discharged; and
an image curing step of curing the image recorded on the recording material in the image recording step by irradiation with actinic radiation.

13. A recorded material formed by using the inkjet ink composition according to claim 1.
